(19) United States
(12) Patent Application Publication
(10) Pub. No.: US 2005/0222789 A1
(43) Pub. Date: Oct. 6, 2005

(54) Automatic test system

(76) Inventor: Burnell G. West, Half Moon Bay, CA (US)

Correspondence Address: DORSEY & WHITNEY, LLP;INTELLECTUAL PROPERTY DEPARTMENT, 370 SEVENTEENTH STREET, SUITE 4700, DENVER, CO, 80202-5647, US

(21) Appl. No.: 10/816,303

(22) Filed: Mar. 31, 2004

(51) Int. Cl. G06F 19/00

(52) U.S. Cl. 702/79

(57) ABSTRACT

Aspects of the present invention involve obtaining a sequence of logic transitions from an integrated circuit that are a function of one or more bits from the integrated circuit (“IC”). The logic transitions from the IC may be representative of one or more data values or bits. For each logic transition, a time is determined. From the time of each logic transition, the pattern of data values is derived. The pattern of data values may then be compared with an expected pattern of data values to test the IC.

### FIELD OF THE INVENTION

The present invention involves automatic test equipment for testing integrated circuits and related assemblies, and more particularly to testing of digital integrated circuits or digital portions of integrated circuits.

### BACKGROUND AND RELATED ART

The fundamental task of automatic test equipment (“ATE”) is to test the functionality of integrated circuits. Generally speaking, an ATE applies a stimulus to the inputs of a device under test (“DUT”) and then compares the actual outputs response to the expected output response for the DUT. More particularly, if the DUT is a digital logic device, the stimulus applied to the inputs and the expected response are digital and are typically represented by data patterns including vectors of ones and zeroes. Such vectors are frequently decomposed into event streams or sequences for the purpose of implementing such tests.

FIG. 1A (Background) illustrates an “event sequence” or “event stream” as those terms are used herein. An “event” is a pair (S, T) where “S” is a state and “T” is the time associated with the transition to S. An “event sequence” is a time-ordered list of such pairs. For example, in the waveform shown in FIG. 1A (Background), the event sequence has four events which can be written as (1, 1), (0, 8), (1, 13), and (0, 18). The first event is driving the signal from a low state to a high state (logic 1) at time=1. The second event is driving the signal from the high state to a low state (logic 0) at time=8. The third event is driving the signal from the low state to a high state (logic 1) at T=13 and the fourth event is driving the signal from the high state to a low state at T=18. Examples of ATEs employing event sequences are available in published literature. One example is disclosed in U.S. Pat. No. 5,212,443 titled “Event Sequencer for Automatic Test Equipment” to West et al. (the “Event Sequencer” patent). In the Event Sequencer patent, digital device test patterns are decomposed into event sequences for each input data path of a DUT and for each output data path of a DUT. This patent describes a fully synchronous test process, wherein the ATE and the DUT operate in full synchronization with a single clock, and the timing of all stimulus applied to the DUT as well as that of all strobing of responses from the DUT are explicitly calculated with reference to the clock. Aspects of the present invention relate primarily to testing the output streams of a DUT.

In some existing ATEs, such as the ATE described in the Event Sequencer patent, testing a DUT involves comparing the actual output response at each pin to the expected output for that pin. For the comparison to deliver a valid result, the DUT output must be strobed at the time when the output is expected to be valid. Thus, the ATE determines the time when the output is valid, and then strobes (or reads) the output at that time. If the tester strobes the output before or after the valid time, it may read in a value, but that value will likely not correspond with the expected value and not yield a valid result.

The Event Sequencer patent describes a method and apparatus for generating the correct time to strobe the DUT output. In the Event Sequencer patent, the correct strobe time is a function of a global period offset or “period vernier” round trip circuitry, calibration, and other delay and timing elements. The period vernier provides a finely graded timing offset of the master test system clocks, used to reference the start of a test. The ATE takes into account the signal round trip time from the ATE, through the DUT, and back to the ATE. Finally, the ATE uses the calibration offset to compensate for ATE path length differences, circuit performance differences, and event types. Various event types, such as drive a logic 0, drive a logic 1, test for a logic 0, and test for a logic 1, are described in the Event Sequencer patent. With regard to the period vernier, each time value associated with a state change (“event time”) is specified by two integers. The first integer represents the number of cycles of a master test system clock since the test began, the second integer represents a portion of the next cycle of the master test system clock.

Since time is a continuous flow, it can be broken up into arbitrarily small time intervals. Commonly, a clock cycle will be divided into a large number of intervals of equal duration, for example 256 intervals, and the second integer will range in value from 0 to 255. In this example, the portion of the next cycle of the master test system clock represented by the second integer is the second integer divided by 256 multiplied by the period of the master test system clock (i.e., the first integer). Such a time representation can be shown in the form (3,112), where the first integer is the cycle count and the second is the numerator of the fraction. If the clock period is 5 ns, then (3,112) represents 15 ns+5*( 112/256) ns, or 17.1875 ns.

As mentioned above, typical ATEs strobe the DUT output and then compare the actual output data to the expected or predicted data or response. If the actual output data agrees with the expected data the test passes, otherwise it fails. The test is absolute, there is no conventional built-in or automatic way to determine the range when the data is valid (the “passing margin”). Stated another way, the passing margin is the range of time when the actual DUT output meets the expected DUT output. It is often the case that the test engineer needs to understand the passing margin. With typical existing ATEs, characterizing the passing margin is performed through a method, sometimes referred to as “searching,” that involves normally adjusting the strobe timing either upward or downward, re-running the test, and determining if the DUT output meets the expected output. To characterize the passing margin, the strobe timing must be incrementally adjusted numerous times and the test rerun to determine the times when the DUT output is correct and when it is not (i.e., the passing margin). Such manual incremental test adjustment and rerunning is time consuming. Moreover, the ATE is occupied during the test, which slows the throughput of the fabrication facility.

Recently, device processing speeds have increased to the point that determining a correct strobe time has become difficult, and in some instances impossible. Exacerbating the difficulty, DUT output timing is often accompanied by variations making it even more difficult or impossible to determine correct strobe timing. Ameliorating the difficulties accompanying the increases in device processing speed is a strongly imposed regularity in the structure of the dataflow. Three such structures are source-synchronous bus clocking, reference-timed bus clocking, and serial data streams with embedded clocks or “self-timed serial data streams.”

Source-synchronous bus clocking systems are disclosed, for example, in U.S. Pat. No. 6,178,206 titled “Method and Apparatus for Source Synchronous Data Transfer.” Generally, in a source synchronous system, data signals are propagated on several signal paths, and their timing is relative to clocking signals transmitted synchronously on another signal path The receiving device uses the synchronously transmitted clock signals to latch the associated data signals. U.S. Publication U.S. 2003/02294156 titled “Test Method and Apparatus for Source Synchronous Signals” to Garcia, which is hereby incorporated by reference herein, illustrates one example of an ATE for testing source synchronous devices.

Reference-timed bus clocking refers to families of signals generated simultaneously with a reference clock signal. The reference clock is synchronous to the signal family on the bus but the receiving device does not explicitly use the reference clock as a latching mechanism. Instead, the receiving device for such signal families generates a clock signal locked to the reference clock and uses the generated clock signal to latch the data. The frequency of the generated clock may be a multiple of the frequency of the reference clock. In such signal families, the reference clock timing varies similarly to the signal family, allowing the receiving device to align its internally generated clock with the data signals.

Self-timed serial data streams are specified in terms of a particular unit interval (sometimes referred to as a “UI”), and allowed variations of this interval known as drift and jitter. FIGS. 1B, 1C, and ID illustrate a source synchronous data bus, a reference clock synchronizing data bus, and a self-timed multilane data bus, respectively. FIG. 1B shows a source synchronous three-bit data bus. The source clock is shown at the top of the diagram. At each source clock edge (rising or falling) the receiving device is expected to register the corresponding data (represented by 1's and 0's in the figure). The source clock and the data streams are all generated in the transmitting device. FIG. 1C shows a three-bit data bus with the reference clock at the top of the diagram. In this case, again, the transmitting device generates both the reference clock signal and the data signals. However, the receiving device does not use the reference clock directly to strobe the data. Instead, it uses the reference clock as a reference signal to generate an internal clock as indicated in the dashed-line waveform. It will be noted that the reference clock must be synchronous with the data, but does not need to have as many transitions as was required for the source clock case, because the receiving device can be enabled to generate the additional transitions. FIG. 1D shows a multi lane self-timed 3-bit data bus. Each of the data streams provides timing information at each of the data transitions. The receiving device must generate a reference clock for each of the data streams, as in indicated by the dashed-line clock waveforms.

Referring to FIG. 1D, the UI of a self-timed serial data stream identifies a region or interval when a data value is valid, and is bordered by region where the data value is uncertain or invalid. In a device employing self-timed serial data streams, every output data transition is expected to occur exactly some integer multiple of the UI from the previous output data transition. “Jitter” is commonly used to identify the deviation between the actual transition time and the expected transition time. Jitter is typically associated with timing deviations between adjacent or nearly adjacent output data transitions. “Drift,” on the other hand, is commonly used to identify timing deviations between data transitions from an expected transition across a sequence of data transitions. For example, if the unit interval specified is 0.1 ns, when transitions occur, the transitions are expected to occur at 0.0 ns, 0.1 ns, 0.2 ns, 0.3 ns, but not at times in between these times. Thus, data should be valid between 0.02 ns and 0.08 ns, then between 0.12 ns and 0.18 ns, then again between 0.22 ns and 0.28 ns, etc.

Since hardware is not perfect, transitions will not occur at exactly these theoretical transition times. They will be displaced somewhat by drift and noise, and the tolerable amount of drift or noise is defined by the device specifications. For example, if transitions occur at 0, 0.11, 0.20, 0.39, 0.60, 0.81, and 1.00 ns, then over the time interval of eleven specified transitions there is a jitter of ±0.01 ns. On the other hand, if the transitions occur at 0, 0.101, 0.202, 0.404, 0.606, 0.808, and 1.01 ns, then there is no jitter but a persistent 1% excessive drift. In other words, in the first case the device clock is apparently correct but the data generation is noisy, while in the second case the clock is apparently too slow while the data generation is apparently very good. It is important to notice that, with 1% drift, even though after 100 unit intervals the transition would be late by one complete unit interval, the correct data can nonetheless be extracted if the receiving circuit can tolerate and compensate for the drift. Current art serial transmission devices allow different clock frequencies provided they are sufficiently close. Serial transmissions using different clock frequencies, such as known PCI Express™ serial transmission technology, require that transmitter and receiver clocks be no greater than 600 parts per million different from each other.

Even compensating for drift, however, it is not possible to predict the timing of some high-speed data streams with sufficient accuracy for synchronous testing because of device variations and a number of other factors, including power supply and temperature drift. As mentioned above, synchronous testing refers to a testing technique where the test system and the DUT are synchronized by the test system clock, and does not refer to source synchronous data busses or reference clock synchronous data busses. For example, a 5 gigabit per second (“GBPS”) data stream will have a UI of 200 picoseconds. Typical device variation due to processing can be three or four times that large (i.e., 600-800 picoseconds); and, variation due to temperature or power supply can easily equal or exceed it. In current high-speed serial transmission technology, the self-timed data streams cannot be strobed, as the clock must be separated first by the receiver. Conventionally, ATEs designed to test serial data streams containing embedded clocks use clock extraction methods or phase shift/sampling methods to test the data streams. Test systems implemented this way can align themselves to the data with sufficient accuracy to determine whether the received data is consistent with expectation but they are unable to measure the deviations of the transitions from their expected times and therefore they cannot measure the error distribution of transitions and automatically determine the passing margin, without rerunning the tests at different strobe timings (i.e., searching).

A logic transition on a device self-timed serial data output pin or differential pin pair separates two successive logic states at the time of the transition. If a transmitting device operates properly (i.e., successive transitions are within device specifications of integer multiples of the pre-established UI), and the data path between the transmitting device and a receiving device is not defective, it is fairly straightforward for a receiving device to decompose a sequence of transitions into a corresponding sequence of logic states representing a digital data word or sequence of words by dividing the time between transitions by the UI. However, if either the transmitting device or the connecting path is defective, the decomposition of the data sequence becomes ambiguous. For example, an output sequence of bits consisting of 001100001111001100 might be improperly sensed as 00110000\ddot{0}111001100 (an extra logic 0, underlined) if the second 0 to 1 logic transition is sensed by the receiving device too late.

Currently, techniques for testing self-timed serial data streams involve two distinct aspects of the data streams. The first aspect is the sequence of data values in the serial data stream. Bit error rates are measured by generating two identical pseudorandom streams of data, one in a transmitter and the other in a receiver; transmitting the pseudorandom stream from the transmitter to the receiver; and comparing the pseudorandom stream received to the one being generated in the receiver. These tests are facilitated today by using a local clock to strobe the data being received. The local clock is extracted from the data stream. Local clock extraction adds error to the testing process, as the clock cannot be extracted exactly.

The second aspect of serial data streams being tested is the timing of the logic transitions that determine the data values. The purpose of testing this aspect is to determine whether a device transmits or receives data accurately, without regard to the specific data patterns being sent or received. Testers focusing on this aspect utilize aggregating types of measurements. One such instrument is disclosed in U.S. Pat. No. 6,456,959, “Time interval analyzer having parallel counters.” Such instruments measure samples of pulses or groups of pulses to determine their statistical behaviors, which may be presented as an eye diagram. These measurements can be used to determine whether the timing component of a data stream satisfies eye diagram requirements, but they are often unable to extract the data for comparison to expected data patterns in a timely fashion.

Time interval measurement is also used for equipment calibration. U.S. Pat. No. 6,081,484 titled “Measuring Signals in a Tester System” and related U.S. Pat. No. 6,285,963 also titled “Measuring Signals in a Tester System”, both to West, involve a device for time interval measurement having parallel counters for such measurements. A characteristic of the test techniques disclosed in the '484 and '963 patents is that the time of a logic transition is measured, rather than being predicted beforehand to enable timely strobing. Detailed analysis of data streams using time interval measurement is possible, typically, when data streams are repeated often, so that the timing of all of the edges can eventually be extracted. In a similar fashion, detailed analysis of data streams can be made with sampling oscilloscopes. After the waveform has been captured, post-capture analysis can extract much useful information. However, in both cases this extraction is not timely.

It is against this background that various embodiments of the present invention were developed.

### SUMMARY OF THE INVENTION

One particular aspect of the invention involves a method for determining a pattern of output bits from an integrated circuit comprising: obtaining a sequence of logic transitions that are a function of one or more bits from the integrated circuit; determining a transition time of each logic transition in the sequence of logic transitions; and deriving the pattern of output bits from the integrated circuit as a function of the transition time of each logic transition in the sequence of logic transitions. The method may further involve the operation of comparing the pattern of output bits from the integrated circuit with an expected pattern of output bits.

With respect to the operation of determining a transition time of each logic transition the method may further involve generating a plurality of transition time windows, each transition time window comprising a range of time when a logic transition of a bit of the pattern of output bits is expected; and assigning each logic transition of the sequence of logic transitions to one of the plurality of transition time windows. The range of time for each transition window may comprise a minimum time when the logic transition of a bit may be assigned to the transition window; a maximum time when the logic transition of a bit may be assigned to the transition window; an earliest time when the logic transition of a bit is expected to occur; a latest time when the logic transition of a bit is expected to occur; and a nominal time when a logic transition of a bit is expected to occur.

With respect to the operation of assigning each logic transition of the sequence of logic transitions to one of the plurality of transition time windows, the method may further involve assigning a first logic transition in the sequence of logic transitions to a first transition time window if the logic transition time falls between a first minimum time that a logic transition may be assigned to the first transition time window and a first maximum time that a logic transition may be assigned to the first transition time window. Further, the plurality of transition time windows may comprise a sequence of time windows arranged such the first transition time window with the first maximum time value is followed be a second transition time window with a minimum time value following the maximum time value of the first transition time window.

With respect to the operation of assigning a first logic transition in the sequence of logic transitions to a first transition time window, the method may further comprise shifting the first logic transition to the second transition window if the logic transition time for the first logic transition exceeds the maximum time value for the first transition window. Further, the operation of deriving the pattern of output bits from the integrated circuit as a function of the transition time of each logic transition in the sequence of logic transitions may comprise generating a bit pattern that is a function of the shift of the first logic transition to the second transition window.

Another particular aspect of the invention involves a method for testing a stream of digital information, comprising: recording an arrival time of each logic transition in the stream; and comparing the arrival time to an expected arrival time for each logic transition in the stream. The one or more data unit intervals may occur between each logic transition in the stream, and the method may further comprise determining a logic value of the one or more data unit intervals occurring between each logic transition. The method may include an additional operation of comparing the logic values of the all data unit intervals with expected logic values.

Further, the method may include the operation of determining a difference between the recorded arrival time of each logic transition with an expected arrival time of each logic transition. The difference between the recorded arrival time and the expected arrival time with limits may be compared with limits. Further, the differences between the recorded arrival times and the expected arrival times may be distributed into histograms.

Another particular aspect of the invention involves a method for receiving a logic data stream, comprising: receiving a logic data stream comprising at least a first logic transition and a second logic transition; recording a first time of the first logic transition; recording a second time of the second logic transition; generating a sequence of time intervals as a function of the specification of the logic data stream; determining a time between the first time and the second time; comparing the time between the first time and the second time with the sequence of time intervals; and determining a bit pattern associated with the logic data stream as a function of the operation of comparing.

The operation of generating a sequence of time intervals may further comprise the operation of multiplying a unit interval time specified for the logic data stream by a sequence of integers. Further, the operation of generating a sequence of time intervals further comprises recording times of a sequence of logic transitions in a second logic data stream. In one particular aspect, the second logic data stream is contemporaneous with the logic data stream.

In another particular aspect, the operation of generating a sequence of time intervals is performed prior to the operation of receiving a logic data stream comprising at least a first logic transition and a second logic transition. Further, the operation of generating a sequence of time intervals may further comprise performing a logic simulation of an apparatus that generates said logic data stream. The apparatus may comprise a device under test.

In one particular aspect, the sequence of time intervals comprises a contiguous sequence of transition windows, each transition window comprising: a minimum time value when a logic transition may be assigned to the transition window; a maximum time value when the logic transition may be assigned to the transition window; a nominal time value when the logic transition may be assigned to the transition window; an earliest time value when the logic transition may be assigned to the transition window; and a latest time value when the logic transition may be assigned to the transition window.

Finally, another aspect of the invention involves, a method for testing a logic data stream, comprising: recording a time of a first logic transition in the data stream; recording a second time of a second logic transition in the data stream; comparing a time interval between the time of the first logic transition and the time of second logic transition to a known sequence of possible interval times; setting a data value determined by said first logic transition time corresponding to the specific interval time in said known sequence of possible interval times; and comparing the data value to a predetermined expected data value.

The features, utilities and advantages of the invention will be apparent from the following description of the various embodiments of the invention as illustrated in the accompanying drawings and claims.

### BRIEF DESCRIPTION OF THE DRAWINGS

FIG. 1A (Background) is a wave form diagram illustrating an “event sequence” or “event stream” as those terms are used herein.

FIG. 1B (Background) is a waveform diagram illustrating data streams and a source synchronous clock of an example source synchronous data bus.

FIG. 1C (Background) is a waveform diagram illustrating data streams and a reference clock of an example reference clock synchronous data bus.

FIG. 1D (Background) is a waveform diagram illustrating data streams of an example self-timed multilane data bus.

FIG. 2 is a high level block diagram of an ATE configured in accordance with some or all aspects of the present invention.

FIG. 3 is a diagram depicting one example of a transition window, in accordance with aspects of the present invention.

FIG. 4 is a flowchart illustrating one method in accordance with aspects of the present invention.

FIG. 5 is a block diagram of a portion of an ATE including an event stream distributor, a plurality of time stamp circuits, and a processing matrix, conforming to aspects of the present invention.

FIGS. 6A-6E are conceptual diagrams illustrating the processing and flow of events after the events are distributed and the arrival time for each event is determined, in accordance with one aspect of the present invention.

FIG. 7 is a waveform diagram illustrating data event streams (data[0]-data[2]), a DUT reference clock stream, and a derived clock stream, in accordance with one aspect of the present invention FIG. 8 is a diagram illustrating a conventional unit interval and associated eye diagram contrasted with two sequential transition windows, in accordance with one aspect of the present invention.

FIGS. 9A-9G, are tables illustrating transition window definitions for a 1.6 GBPS data stream, a test system clock with a 2500 picosecond period, a test system clock fractional resolution of 256 bits, a least significant bit (“LSB”) of 9.766 picoseconds a transition window unit interval size of 64 bits (0-63), and a 12.5% margin, which is the allowed deviation of a transition edge from the nominal transition edge, expressed as a percentage of the transition window unit interval in accordance with one aspect of the present invention

FIG. 10 is a diagram illustrating a logic transition occurring in the boundary region of two adjacent clock pulses, an example of a logic transition received late in a split window being moved from the late portion of a split window in one tester cycle to the correct early portion of the split window one tester cycle ahead in the data pipeline, in accordance with one aspect of the present invention.

FIGS. 11A-11B are conceptual diagrams illustrating an alternative of the processing and flow of events after the events are distributed and the arrival time for each event is determined, in accordance with one aspect of the present invention

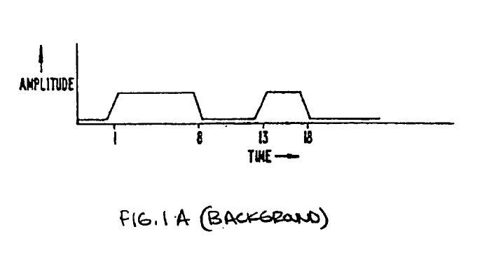

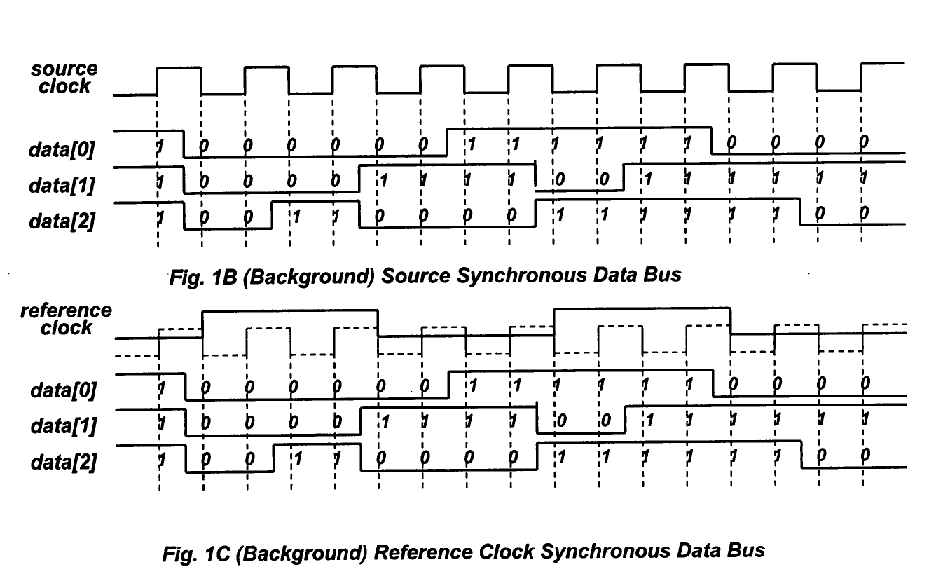

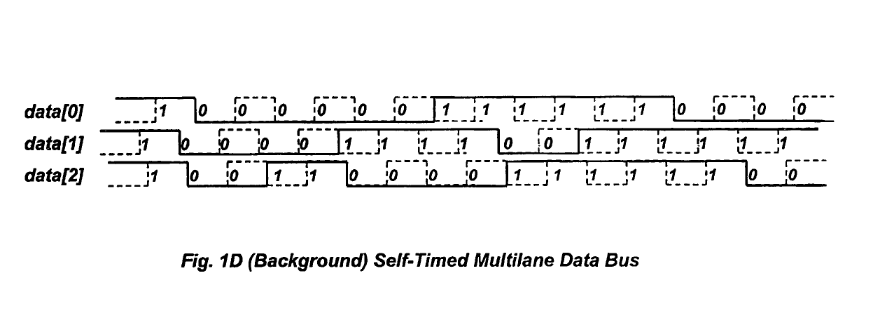

### DETAILED DESCRIPTION OF EMBODIMENTS OF THE INVENTION

Aspects of the present invention apply the concept of measuring event edge timing to the fundamental task of automatic test systems for digital integrated circuits. An ATE employing aspects of the present invention generates and applies a digital pattern to one or more DUT inputs. Unlike some conventional ATE that strobe the DUT output at a predicted time, an ATE conforming to aspects of the present invention determines when DUT output data transitions are expected, measures the time of each transition generated by the DUT, and compares the two. Unlike conventional testing techniques, aspects of the present invention do not require strobing to extract the data stream. Rather, the data stream is extracted by calculating data stream values, such as logic 0s and 1s from the measurement of the transition. Conventional ATEs, such as described in the Event Sequencer patent, strobes the device output pins at test program specified times, and as a result of the strobe determine whether the device output was one or zero at the strobe time. In known prior art, the passing margin, described earlier, cannot be determined automatically or directly.

In one particular implementation, an ATE employing aspects of the present invention generates a sequence of transition windows that are a function of the expected transition or arrival time for each event. Initially, the ATE records the arrival time of each event from a DUT and assigns each event to a transition window. The recorded arrival time of each event is compared with expected arrival time defined by the transition windows. Based upon the comparison, if the time of the event matches the transition window time values, then it is assigned correctly. If not, the event is moved into the correct transition window. When the events are assigned to the proper transition windows, the ATE may compare the received data pattern to an expected data pattern. Moreover, the ATE may resolve the bit patterns from the event sequences, and compare the bit patterns to the expected bit patterns. In this way, embodiments of the present invention produce data patterns representing the device output in a natural way. The resolved data patterns are presented in digital form, allowing comparison to expected patterns in a timely and direct way. The data patterns may also be recorded for later analysis. Received data may be organized into data words of constant width, irrespective of the data rate at which they were received.

Aspects of the present invention also provide several additional advantages. For example, implementations of the present invention may automatically quantify the passing margin, allowing collection of DUT performance statistics on the fly. At the same time, the DUT output may be compared to expected values. In other words, an ATE employing aspects of the present invention may provide absolute results as to whether an output sequence matches an expected pattern and at the same time quantify the margin of passing. Implementations of the present invention may also eliminate the need to predict individual device output timing with precision for the entire duration of a digital test, enabling correct reception of source-synchronous or self-timed data streams. This is advantageous because the flow of data from test program memory can be reduced. The test program does not need to contain individual timeset values for each bit to be tested.

Implementations of the present invention may also incorporate means to track timing of self-timed or source-synchronous data streams without explicitly extracting a clock signal. This is advantageous because the drift of the signal can be recorded and compared to requirements, and because the circuitry required to extract a clock signal is complex and consumes power. It is also advantageous because edge position errors do not accumulate beyond the error incurred in the original recorded time value. Depending on any particular implementation, some or all of the above-described advantages may be achieved.

Implementations of the present invention may utilize technology described in U.S. patent application publication U.S. 2003/0139899 titled “Circuit and Method for Distributing Events in an Event Stream,” which is hereby incorporated by reference herein, and referred to as the “Event Distributor” patent, technology, or the like. Implementations of the present invention may further utilize technology described in U.S. Pat. No. 6,501,706 titled “Time-to-Digital Converter,” which is hereby incorporated by reference herein, and referred to as the “Time Stamper” patent or technology. The Time Stamper patent describes methods and apparatus for “time stamping” an event which involves establishing the time of a logic transition, such as the logic transition of a DUT output event stream. The Distributor patent describes methods and apparatus to distribute time-stamped events in an event stream to a plurality of channels for processing.

Some embodiments of the invention involve taking a distributed set of time-stamped event streams and transforming it into the digital bit stream transmitted by the device being tested. Aspects of the invention define a sequence of time windows within which transitions are expected to occur whenever there is a change in state in the bit stream being recorded. The starting of the time bit stream initializes the sequence of time windows. The first logic transition establishes the logic value of the first bit in the data stream. The timing of each logic transition after the first, together with the specification of UI associated with the data bits in the event stream, determines the number of bits of the current logic value and at the same time establishes the exact time of the transition to a new logic value as well as the new logic value.

As noted above, some implementations of the invention determine the proper timing of the windows. If the device can be completely synchronized to tester timing, as is currently done in ATE, the time windows can be calculated in advance and provided to the tester at the start of a test. However, since some devices cannot be controlled well enough for fully synchronous testing when the I/O is too fast, implementations of the invention may provide a way to recalculate the window timing parameters on the fly during the course of the test, if needed.

For source-synchronous devices, the means to be provided depends on times recorded for the source clock. The source clock itself generates a sequence of time stamps, just as do the pins in the associated data bus. For reference clock timed data buses, the reference clock provides a series of transitions whose time stamps bear a synchronous determinate relationship to the transitions in the several streams of the data bus. For self-timed devices, each transition within a data stream provides data that can be used to update window time value parameters. Coherent reception of self-timed data streams requires that each transition be consistently associated with a particular expected arrival time based on the prespecified UI and the timing of previously sensed transitions. Consequently, computing the expected arrival time prior to the time a transition occurs is clearly possible. Each transition in a self-timed data stream occurs within tolerable error limits of an expected transition time. If the transition is outside of those error limits, then the data stream might be corrupted as noted earlier.

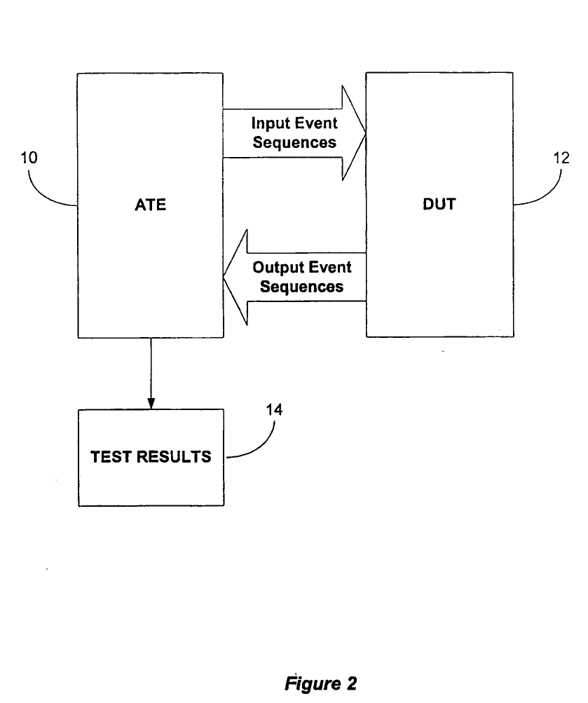

FIG. 2 is a high level block diagram of an ATE 10 configured in accordance with some or all aspects of the present invention. The ATE is arranged to supply a test pattern, such as an input event sequence, to one or more pins of a DUT 12. Further, the ATE is configured to receive an output pattern, such as an output event sequence, from one or more pins of the DUT. The ATE then analyzes the output event sequence, such as by comparing the output pattern to an expected pattern, to determine if it is correct and provides test results 14.

In one implementation of the present invention, the ATE 10 generates DUT 12 input sequences in accordance with U.S. Pat. No. 5,212,443 titled “Event Sequencer for Automatic Test Equipment,” which is hereby incorporated by reference herein, and generally referred to as the “Event Sequencer” patent, technology, or the like. The DUT processes the input sequences and generates outputs on one or more output pins.

The ATE 10 receives the output pattern from the DUT 12. In one example, a DUT output may be characterized as a stream of events (“output event stream”). The ATE receives the output event stream from one or more single signal sources or output pins of the DUT. Each event involves a transition from a first logic state to a second logic state. Depending on the rate of the incoming event stream, the ATE may distribute the stream of incoming events to a plurality of secondary event streams. Additionally, the ATE 10 determines the time that each event is received by the ATE (the “arrival time” or “actual arrival time”). When distribution is necessary, the incoming event stream from the DUT is referred to as a “primary” event stream. As used herein, however, the term “primary event stream” or “event stream” is meant to generally refer to the incoming event stream from the DUT 12 whether or not distribution into secondary event streams is necessary. Moreover, the term “secondary” event stream is meant to generally refer to an event stream that is a function of the incoming event stream, which in most instances will involve a distribution of the primary event stream into a plurality of secondary event streams.

Before or during testing of the DUT 12, the ATE 10 or other processing device, which may be separate from the ATE, generates a sequence of transition windows that are a function of the time when data transitions or events of an incoming data stream are expected to arrive at the ATE (the “expected arrival time”). The arrival times of the events in the primary or secondary events streams are compared to corresponding expected arrival time values associated with the transition windows. Through one or more comparisons, the events are assigned to the transition window with an expected arrival time value that matches the actual arrival time value. When events are properly arranged in the corresponding transition window, the bit or data pattern of the incoming stream is established, which may be compared to the expected data pattern. Moreover, the precise timing of each bit or event is established along with other timing information for each bit; thus, allowing the passing margin to be quantified without having to perform a searching or similar technique involving repeated execution to the test pattern and repeated comparison with results to expected patterns.

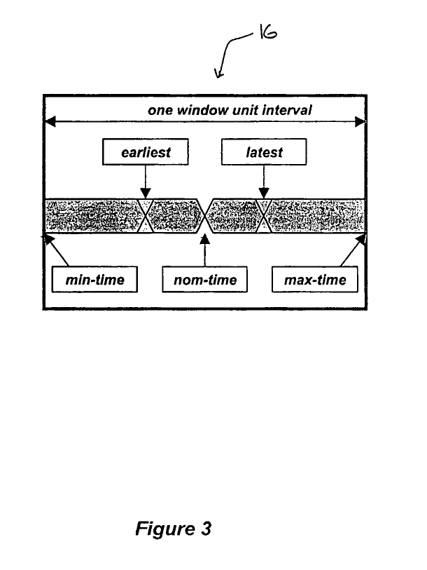

FIG. 3 is one example of a transition window 16, in accordance with one aspect of the present invention. The transition window has five associated time values computed based on when an event is expected (e.g., when a transition from logic 0 to 1 or logic 1 to 0 is expected). The width of the transition window, or window unit interval (“WUI”), is defined by the time difference between a minimum time value when an event may be assigned to the transition window and a maximum time value when an event may be assigned to the transition window. The nominal time value of an event is at the middle of the transition window (between the minimum time value and the maximum time value), and represents the nominal time when an event transition is expected. Thus, in contrast to the unit interval of a self-timed serial data stream which is centered on when a data value is valid, i.e., when a data value is stable at a high state (logic 1) or low state (logic 0), the transition window of various implementations of the present invention is centered on when a data transition is expected, i.e., where the data value is transitioning between states. The transition window also includes an earliest and latest time value to either side of the nominal value. The earliest and latest time values are associated with the earliest and latest time, respectively, that a valid event may be received according to device specifications. The transition window 16, associated time values, and their use in precisely deriving incoming bit patterns is discussed in more detail below.

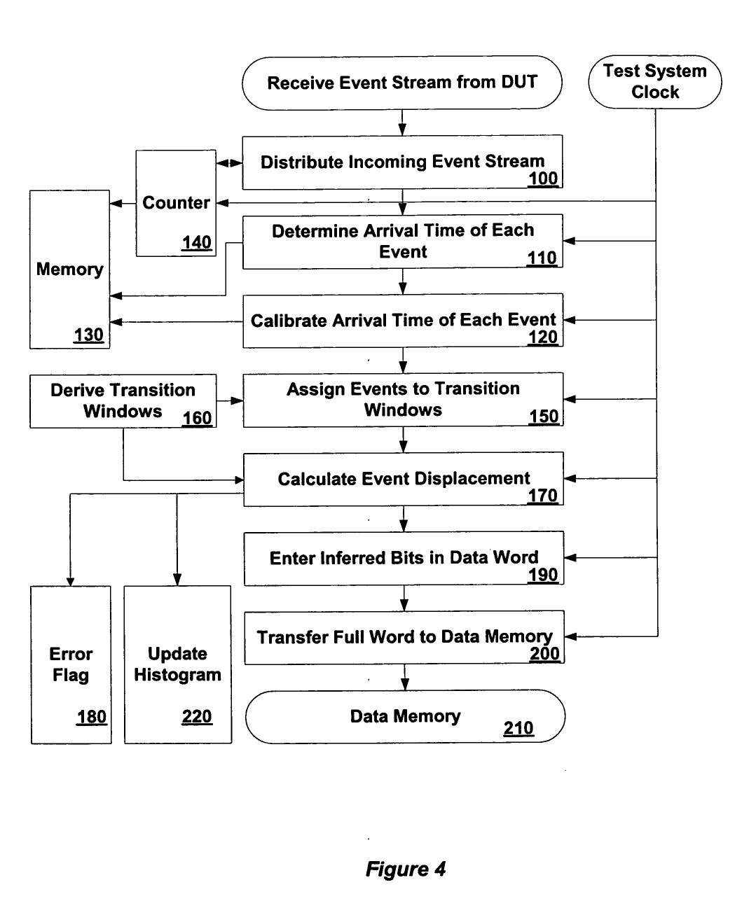

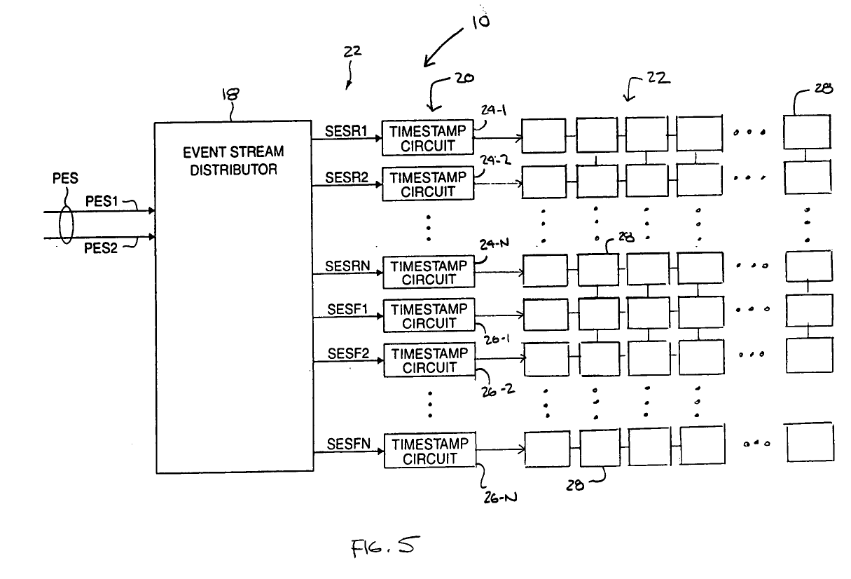

FIG. 4 is a flowchart illustrating one method in accordance with the present invention. In the first operation 100, the ATE 10 receives an incoming data stream or “event stream” from a DUT 12 and distributes the event stream into a plurality of secondary event streams for further processing. The stream of events typically will originate from a single signal source from the DUT. The ATE may be configured to process a plurality of event streams. The signal source may be a single DUT pin or a differential pair of DUT pins. One method and apparatus for distributing the incoming or primary event stream into a plurality of secondary event streams is discussed in U.S. patent application publication U.S. 2003/0139899 titled “Circuit and Method for Distributing Events in an Event Stream,” which is hereby incorporated by reference herein, and referred to as the “Event Distributor” patent, technology, or the like. While the methods and apparatus disclosed in the Event Distributor patent describe one preferable way to implement the first operation, implementations of the present invention may not distribute the incoming data stream or may employ other methods or apparatus.

In operation 110, after distribution, an ATE employing aspects of the present invention establishes the arrival time of each event in the secondary event streams.

FIG. 5 is a block diagram of a portion of an ATE conforming to aspects of the present invention. The portion of the ATE 10 shown includes an event stream distributor, a plurality of time stamp circuits 20, and a matrix of computational cells 22. Generally, at the event stream distributor, the ATE 10 receives a primary event stream (“PES”) from a DUT 12 and distributes the primary event stream into a plurality of secondary event streams (“SES”). The secondary event streams are transmitted to corresponding time stamp circuits 20 that establish an arrival time for each event, according to one particular implementation of the present invention. The SES have a lower rate than the primary event stream, but the relative timing of events in the primary event stream is maintained in each of the secondary event streams. Each of the secondary event streams is in communication with a time stamp circuit, which determines or records the times at which events in the secondary event streams occur. As will be discussed in further detail below, the time-stamped events from the time stamp circuits are then passed to the computational matrix 22 for further processing, in accordance with aspects of the present invention.

Referring more particularly to the distribution and time stamping aspects, the event stream distribution 18 and time stamp circuits 20 may collectively be referred to as a “time stamp system.” Time stamp system 22 includes the event stream distributor 18, time stamp circuits 24 (separately labeled 24-1, 24-2, . . . , 24-N, where N=1, 2, 3, . . . ), and time stamp circuits 26 (separately labeled 26-1, 26-2, . . . , 26-N, where N=1, 2, 3, . . . ). Time stamp system 22 receives a primary event stream PES that includes events. In the embodiment shown, primary event stream PES is a differential signal that consists of two signals: non-inverted primary event stream PES1 and inverted primary event stream PES2. In other embodiments, primary event stream PES can be a single-ended signal.

An event stream is an electronic signal having multiple events. As already mentioned, the electronic signal having multiple events can be a single-ended signal or a differential signal. A single-ended signal consists of a single signal. In this case, the term “event” refers to a transition from a low level to a high level (i.e., a rising edge transition) or a transition from a high level to a low level (i.e., a falling edge transition). On the other hand, a differential signal consists of a pair of signals. The first signal is at a logic high level whenever the second signal is at a logic low level, and the first signal is at a logic low level whenever the second signal is at a logic low level. In this case, the term “event” refers to a transition from a high level to a low level on one signal and a simultaneous transition from a low level to a high level on the other signal. The “time” of a single-ended signal type of event is when a rising edge or falling edge transition occurs. The “time” of a differential signal type event is the moment when the voltages on the two signals are equal.

Event stream distributor 18 distributes the events in non-inverted primary event stream PES1 among multiple rising edge secondary event streams SESR (separately labeled SESR1, SESR2, . . . , SESRN, where N=1, 2, 3, . . . ). More specifically, event stream distributor 18 distributes the rising edge events in non-inverted primary event stream PES1 such that the first rising edge event is provided to time stamp circuit 24-1, the second rising edge event is provided to time stamp circuit 24-2, . . . , the Nth rising edge event is provided to time stamp circuit 24-N, the N+1^{th} rising edge event is provided to time stamp circuit 24-1, the N+2^{th} rising edge event is provided to time stamp circuit 24-2, . . . , the Nth rising edge event is provided to time stamp circuit 24-N, and so on. Similarly, the event stream distributor distributes the events in inverted primary event stream PES2 among multiple falling edge secondary event streams SESF (separately labeled SESF1, SESF2, . . . , SESFN, where N=1, 2, 3, . . . ). More specifically, event stream distributor distributes falling edge events in inverted primary event stream PES2 such that the first falling edge event is provided to time stamp circuit 26-1, the second falling edge event is provided to time stamp circuit 26-2, . . . , the N^{th} falling edge event is provided to time stamp circuit 26-N, the N+1^{th} falling edge event is provided to time stamp circuit 26-1, the N+2^{th} falling edge event is provided to time stamp circuit 26-2, . . . , the 2N^{th} falling edge event is provided to time stamp circuit 26-N, and so on.

Referring again to FIG. 4, after distribution of the primary event stream into one or more secondary event streams (operation 100), implementations of the present invention determine the arrival time for each event in the event stream (also referred to as a “time stamp”) in operation 110. Referring again to FIG. 5, time stamp circuits 20 generate a time stamp for each event that occurs in their respective secondary event streams. An exemplary time stamp circuit, which can be used for time stamp circuits 20, is disclosed in commonly assigned U.S. Pat. No. 6,501,706 titled “Time-To-Digital Converter,” which is hereby incorporated by reference herein, and referred to as the “Time Stamp” patent, technology, or the like.

The time stamp circuits 20 are responsive to a reference clock that creates a digital representation of the time at which an event occurs, in one example. The digital representation of the time at which an event occurs has two components. The first component is the specific clock cycle of the reference clock within which the event occurs. The second component is the time at which the event occurs within the specific clock cycle of the reference clock. Since each event is represented by the two components which are generated with respect to a reference clock, subsequent processing steps can determine timing relationships between each event which is useful when debugging/testing an integrated circuit device.

More particularly, the first component is the leading edge of the specific reference clock cycle within which the event appears, and the second component is an integer M<N, where NdT is equal to the period of the reference clock and M is a number of time intervals dT after the leading edge of the reference clock such that the event occurs between MdT and (M+1)dT. Thus, multiple time stamp circuits 20 of this type can each receive a secondary event stream from the event stream distributor 18 and record the times at which events occur in each of these secondary event streams. Since the relative timing of the events in the primary event stream is maintained in each of the secondary event streams, the timing of the events in the primary event stream can be reconstructed and thus used when debugging/testing an integrated circuit device.

Commonly, a clock cycle will be divided into a large number of intervals of equal duration, for example 256 intervals, and the second integer will range in value from 0 to 255. In this example, the portion of the next cycle of the master test system clock represented by the second integer is the second integer divided by 256 multiplied by the period of the master test system clock (i.e., the first integer). Such a time representation can be shown in the form (3,112), where the first integer is the cycle count and the second is the numerator of the fraction. If the clock period is 5 ns, then (3,112) represents 15 ns+5*( 112/256) ns, or 17.1875 ns.

It should be recognized that the primary event stream PES can be distributed across any number of secondary event streams SES. As those of ordinary skill in the art will recognize, the number of secondary event streams SES required in a particular application is a function of (1) the maximum expected event rate in the primary event stream PES; and (2) the minimum period of time that must elapse between consecutive events for a particular type of time stamp circuit 20 to accurately record all of the events in the primary event stream PES. It should be further recognized, that some implementations of the prevent invention may not require distribution or an event stream distributor 18.

Referring still to FIG. 5, the output of each time stamp circuit is fed into the processing matrix 22 comprising a plurality of computational cells 28. The matrix of computational cells performs the calibration and other operations discussed in detail below.

Referring again to FIG. 4, following distribution of the incoming data stream of events and establishment of event timing for each event (operations 100 and 110) is a calibration operation 120. In one implementation of the invention, the event time value generated by the time stamp circuit is a “raw” time value number that requires correction through the calibration operation. As used herein, the term calibration refers to both linearization and deskewing operations. In some instances calibration may not be required to employ implementations of the invention. In other instances, only linearization or deskewing, but not both will be required. Calibration is discussed in greater detail below.

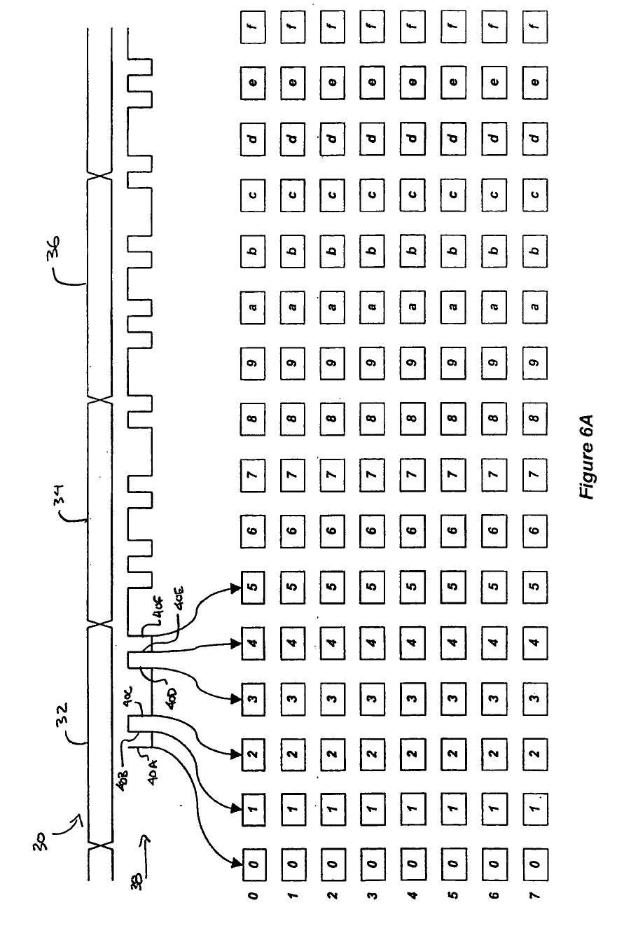

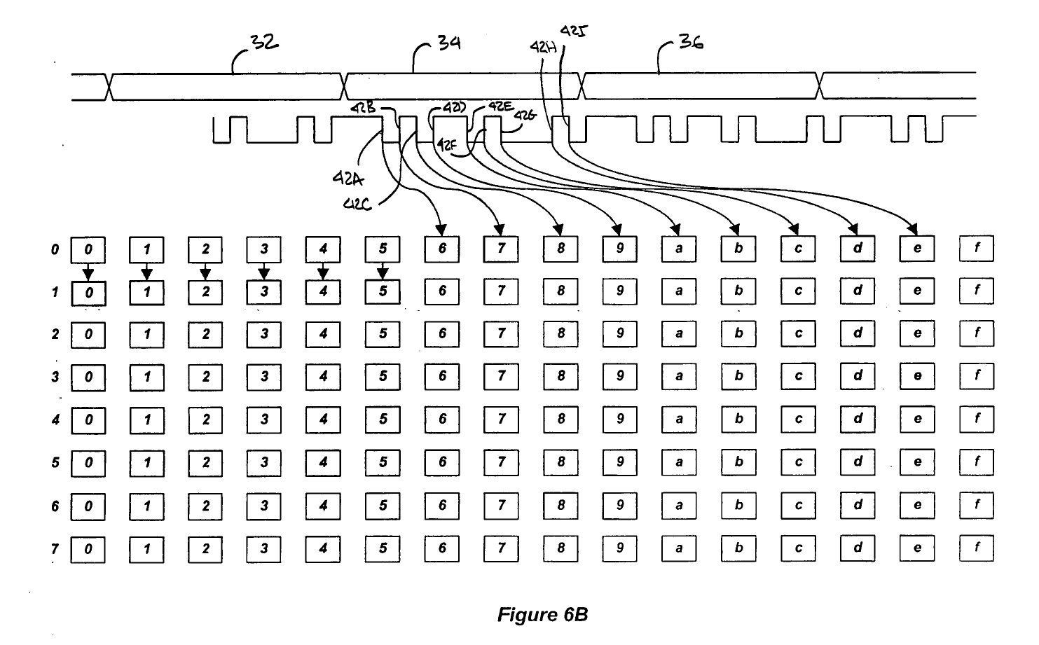

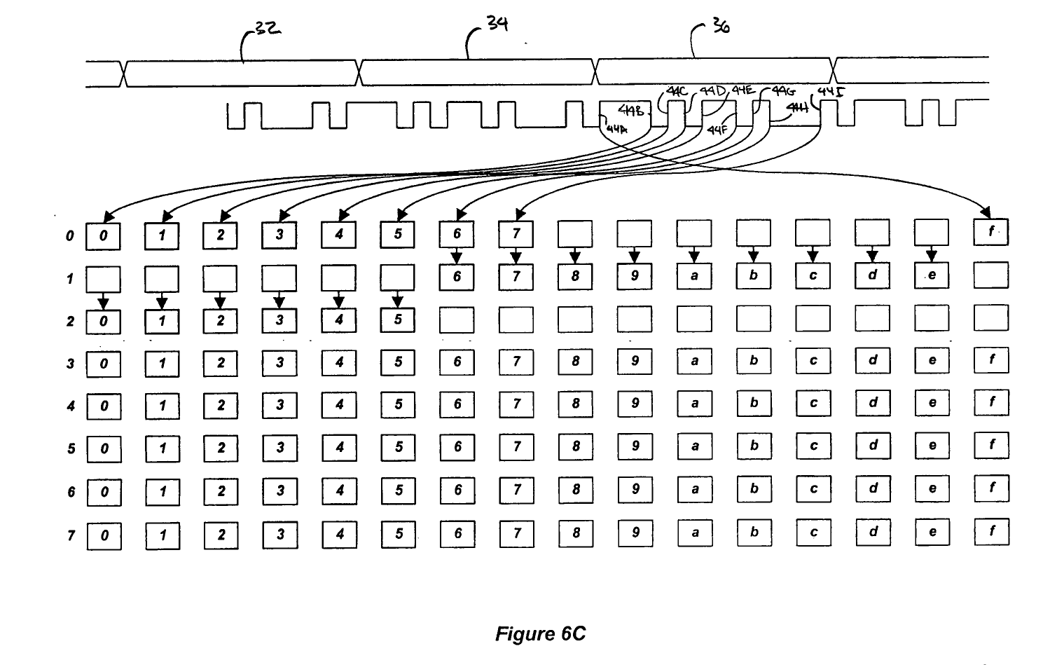

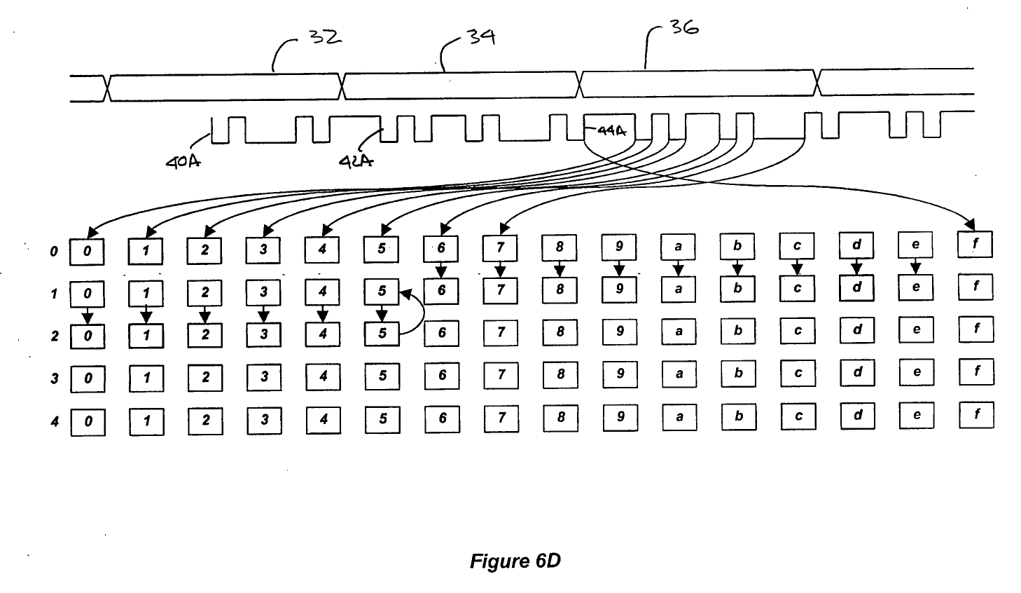

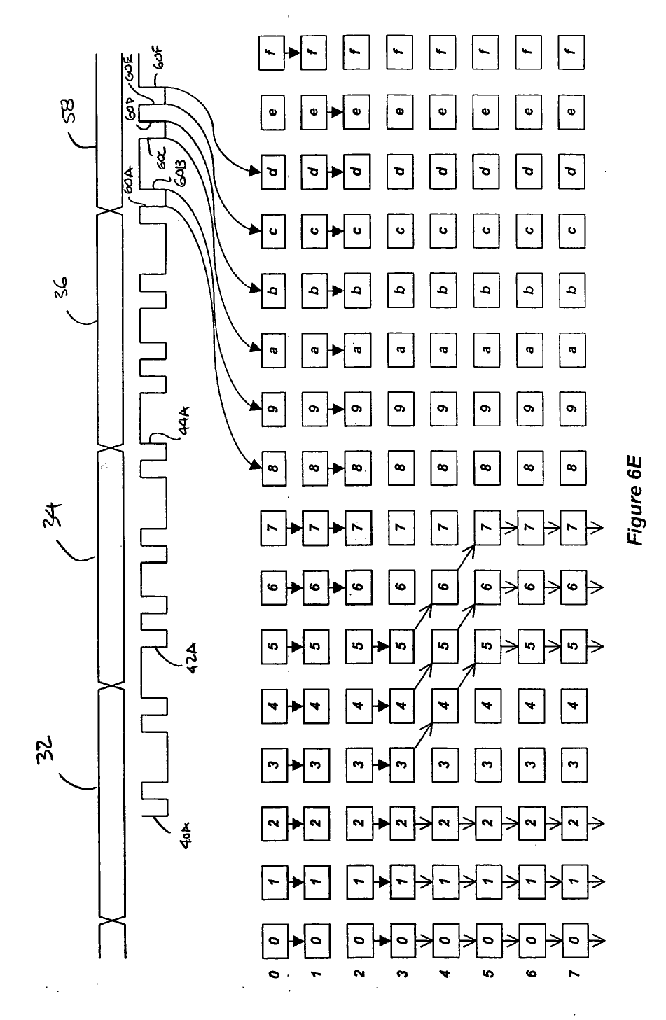

FIGS. 6A-6E are conceptual diagrams illustrating the processing and flow of events through the computational cells 28 after the events are distributed and the arrival time for each event is determined. Along the top of the diagrams is a wave form for a test system clock 30. The test system clock is a differential signal, and three complete clock events or clock pulses are shown (i.e., clock pulse one 32, clock pulse two 34, and clock pulse three 36). Below the test system clock wave form, is an example of a DUT output data pattern 38, i.e., an output event sequence or stream to be captured and tested by the ATE. In this example, the DUT output data pattern or “primary event stream” is a single-ended signal. Finally, below the DUT output data pattern is a representation of one example of the processing matrix of computational cells 28. The computational cells shown below the primary event stream are arranged by column and row. As will be more evident from the following discussion, each column is initially associated with a secondary event stream. As shown in FIG. 5, in one implementation, each column of the processing matrix is in communication with one of the time stamp circuits 20. Conceptually, the group of arrows between the event stream and pointing to the top of the columns of the matrix, refer to the outputs of the time stamp circuits.

Generally, the matrix illustrates an array of computation cells with enough width to capture all the time stamped events within a test system clock cycle, and enough depth to sort the events into a proper transition window. Thus, the width and depth may vary according to a particular implementation. For example, if the test system clock period is 2.5 ns and the maximum data rate to be tested is 6.4 GBPS, then there can be as many as 16 transitions in a single test system clock cycle, which involves a 16-wide array of computational cells. Each row of the processing matrix represents one test system clock cycle, and corresponds to one pipeline stage of data processing in the array. The word “row” and the phrase “pipeline stage” will be used interchangeably in the following. Although illustrated as an array of discrete interconnected computational components (note all the interconnections are not explicitly shown), such as ASICs, it is possible to combine functional tasks into different arrangements of processing elements. Moreover, functional tasks of each cell may be performed through hardware, software, or a combination thereof.

As discussed above, a primary event stream comprises a sequence of “events” corresponding to each transition, either from high to low or low to high. FIG. 6A conceptually illustrates the actions during the first test system clock pulse 32 and the start of a test. In one example, all events during the first complete clock pulse are sequentially distributed to the top of the columns in the first row (row 0) of the matrix. An initializing event, which is the first event in the incoming data stream, involves a transition from high to low (logic 0) that occurs about midway through the first full test system clock pulse shown.

At the start of a test, in one implementation of the invention, the ATE generates a signal to enable the ATE 10 to accept output data patterns being generated by the DUT 12. The ATE is also generating DUT input event sequences, such as with the technology described in the Event Sequencer patent, that generate the output data patterns. The DUT output data stream will start at some time not necessarily aligned with the test system clock. In the example of FIGS. 6A-6E, the first or initializing event of the output data stream is received about midway in the first test system clock cycle 32. In the example primary event stream, a high value is representative of a logic 1 and a low value is representative of a logic 0. The first event 40A involves a transition from a high value (logic 1) to a low value (logic 0), and is recorded as a logic 0. Through the event distribution 18 and time stamping circuitry 20 discussed above, the first event is distributed to a secondary event stream and time stamped. Because it is the first event, it is distributed to the first secondary event stream, which is routed to the first computational cell (cell 0) of the first row (row 0). As discussed in detail below, in an alternative implementation, the ATE does not generate an enable signal, but rather waits for a transition on the data stream.

The five events (40B-40F) following the first event 40 also occur during the first full test system clock pulse 32. With reference to the first event, one bit time later a transition to logic 1 occurs (40B), followed by a transition to 0 (40C), then three bit times later a transition to 1 (40D), followed by a transition to 0 (40E) and a transition to 1 (40F). As such, it should be recognized that the event rate of the primary event stream is higher than the event rate of the test system clock 30. The second event (40B) is a transition from low (logic 0) to high (logic 1) that is time-stamped and distributed to the top or first cell (cell 1) of row 0, column 1. The terms “column,” and “channel” are used interchangeably herein, and refer to computational cells shown aligned in a column with the same or similar (after adjustment) transition window values, which are discussed in more detail below. The third event 40C is a transition from high to low that is time-stamped and distributed to the top or first cell of channel 2. The fourth event 40D is a transition from low to high that is time-stamped and distributed to the top or first cell of channel 3. The fifth event 40E is a transition from high to low that is time-stamped and distributed to the top or first cell of channel 4. Finally, the sixth event 40F is a transition from low to high that is time-stamped and distributed to the top or first cell of channel 5. The first cell of each channel is in the first row of the processing matrix.

In the first clock cycle 32 in the capturing sequence, six events (40A-40F) have occurred and have been captured and registered in the first row of computation cells. Each event is associated with a logic value and an actual arrival time value time stamp. The first event is associated with a logic 0, and a time stamp of (0, Tₒ), where 0 represents the first clock pulse and Tₒ represents a digital value between 0 and 255 representative of the time within the first clock pulse 32 that the first event occurred. Similarly, the subsequent five events (40B-40F) are associated with the logic values 1, 0, 1, 0, 1, respectively. Further, the subsequent five events are associated with arrival time values (0, T₁₋₅) where 0 represents the first clock pulse, and (0, T₁-T₅) represent digital values between 0-255 representative of a time within the first clock pulse that the second-fifth events occurred. This completes the capture sequence for the first test system clock cycle. Subsequent DUT output transitions occur in subsequent clock cycles.

Reflective of typical digital signals coming from a DUT where data is represented by nearly any conceivable combination of logic 1's and 0's, events in the primary event stream do not occur at a regular interval. For example, from the primary event stream, it can be seen that the time between the third event 40C and the fourth event 40D is longer than the time between the first event 40A and the second event 40B as well as the time between the second event 40B and the third event 40C. For perspective, the pulse defined between the first event and second event is a single logic 0. The pulse defined between the second event and the third event is a logic 1. The larger pulse between the third event and the fourth event is, in effect, three successive logic 0's. As such, the distributed primary event stream is 010101, but the bit sequence associated with the first six events is 01000101. As will be recognized from the discussion below, in accordance with one implementation of the present invention, the computational matrix receives the secondary event streams, and precisely establishes the bit pattern and the precise time of each bit of the primary event stream. The precisely reconstituted bit pattern may then be compared with an expected bit pattern to test the functionality of the DUT 12.

FIG. 6B illustrates the actions that occur during the second complete clock pulse 34. During the second clock pulse the events routed to the first row (row 0) of the computational matrix move down to the second row (row 1) for the linearization portion of the calibration operation 120. In one implementation of the invention, row 1 of the computation cell matrix is configured with, or in communication with, a lookup table used to linearize the arrival time of each associated event. As discussed below, linearization is the first portion of the time stamp calibration operation, in one particular implementation of the invention. Calibration takes place, in one implementation, in the second (row 1) and third row (row 2) of the computational matrix. Also, calibration may begin when the secondary event streams are first sent to row 0 of the processing matrix. Also, during the second test system clock pulse, all incoming events occurring during the second clock pulse are distributed to the next available sequence of cells in the first row.

Referring first to the distribution of events during the second clock pulse, nine events (42A-I) are distributed to cells 6-e (the seventh through fifteenth cells) in row 0 of the processing matrix. The seventh event 42A (the first event during the second clock pulse) involves a transition from high (logic 1) to low (logic 0) and is recorded as a logic 0. The seventh event is assigned a time value (1, T₆) and distributed to cell 6 (first row) of the seventh column (column 6) in the processing matrix. As the sixth event 40E (distributed during the first clock pulse) was sent to cell 5 in the first row, cell 6 in the first row is the next available cell for the seventh event. As each cell in the row is associated with a transition window and the transition windows are defined sequentially, the events are at first distributed sequentially or contiguously across the rows. The eighth event 42B involves a transition from low (logic 0) to high (logic 1), is recorded as a logic 1, assigned arrival time value (1, T₇) and is distributed to cell 7 in the first row. The ninth event 42C involves a transition from high (logic 1) to low (logic 0), is recorded as a logic 0, assigned arrival time value (1, T₈) and is distributed to cell 8 in the first row. The tenth event 42D involves a transition from low (logic 0) to high (logic 1), is recorded as a logic 1, assigned arrival time value (1, T₉), and is distributed to cell 9 in the first row. The eleventh event 42E involves a transition from high (logic 1) to low (logic 0), is recorded as a logic 0, assigned arrival time value (1, Tₐ), and is distributed to cell “a” in the first row. The twelfth event 42F involves a transition from low (logic 0) to high (logic 1), is recorded as a logic 1, assigned arrival time value (1, T_{b}), and is distributed to cell “b” in the first row. The thirteenth event 42G involves a transition from high (logic 1) to low (logic 0), is recorded as a logic 0, assigned arrival time value (1, T_{c}) and is distributed to cell “c” in the first row. The fourteenth event 42H involves a transition from low (logic 0) to high (logic 1), is recorded as a logic 1, assigned arrival time value (1, T_{d}) and is distributed to cell “d” in the first row. Finally, the fifteenth event 42I involves a transition from high (logic 1) to low (logic 0), is recorded as a logic 0, assigned arrival time value (1, Tₑ) and is distributed to cell “e” in the first row. Thus, the sequence of events during the second clock pulse is 010101010. The bit pattern associated with the sequence of events during the second clock pulse is 11010110100010.

As mentioned above, the linearization portion of the calibration operation 120 may occur in the second row of the processing matrix. As shown in FIG. 6B, the first six events (40A-40F) distributed into row 0 during the first clock pulse 32, are transferred into row 1 (in the same columns) during the second clock pulse 34. Linearization involves assigning a time value associated with the raw digital value from the time stamper circuit. In one implementation, the raw value defines an address of a look-up table defining time values associated with each address. The look-up table may be implemented with a memory array. Thus, during linearization, through a look-up operation, each event is assigned a time value. In one implementation, the linearization table is defined by generating a precise data stream synchronized with the test clock but offset by a precisely controlled phase difference. All channels of the time stamper circuit log the raw time stamps, from which the entries of the look-up table are generated. The paper titled “The Path to One-Picosecond Accuracy,” by Luca Sartori and Burnell West and published in the Proceedings IEEE International Test Conference 2000, Atlantic City, N.J., USA, October 2000, pp. 619-627, which is hereby incorporated by reference herein, discusses one implementation of a linearization operation and related methods employable with implementations of the present invention.

For an example of linearization, suppose the time stamp is 207 for a particular event established by the calibration setup to be precisely 110/256 of a clock cycle after a specific clock edge. In this case, the linearization table entry at address 207 will be 110. In later operation, when a time stamp of 207 is generated, then the value 110 will be extracted from the linearization table by referring to the contents of the table at address 207. It is preferable that the table be filled completely by calibration measurements or interpolations of them. In one particular implementation, the number of table entries is 2048, and the target resolution is 1/1024 of a clock cycle rather than 1/256 of a clock cycle. The number of table entries is larger because it is not generally possible to obtain perfect linearity and it is desirable to minimize large gaps in the linearized result. The larger table size naturally results in multiple time stamps resolving to the same linearized result.

FIG. 6C illustrates the actions that occur during the third test system clock cycle 36. During the third clock cycle, the first distributed events (40A-40F) in cells 0-5 of the second row to move down to cells 0-5 of the third row for a deskewing operation. The second distributed events (42A-42I) in cells 6-e of the first row move to cells 6-e of the second row for linearization (as discussed above). Finally, the events occurring during the third test system clock pulse are distributed to cell “f” of the first row (the top cell of the last column) and cells 0-7 also of the first row.

Referring first to the distribution of events during the third clock pulse, the sixteenth event 44A (the first event during the third clock pulse) involves a transition from low (logic 0) to high (logic 1), is recorded as a logic 1, and assigned arrival time T_{f}. The sixteenth event is assigned a time value and distributed to cell “f” of the first row in the processing matrix. As the fifteenth event 42I (distributed during the second clock pulse) was sent to the cell “e” in the first row, cell “f” in the first row is the next available cell for the sixteenth event.

The seventeenth event 44B is a transition from high (logic 1) to low (logic 0), is recorded as a logic 0, assigned arrival time (3, T₀) and is distributed to the first cell (cell 0) in the first row. In this example, there are sixteen computational cells in the first row, corresponding to 16 possible incoming DUT transitions that may occur during a given clock cycle. When the seventeenth event is reached, the events begin distributing again to the first cell in the first row. Since the events from the first and second test system clock cycles (32, 34) previously occupying the first fifteen cells of the first row have been transferred from the first row, there is now room to process new events in the first 15 cells (cell 0-e) of the first row. T₀ is used to refer to the offset value between the arrival time of the seventeenth pulse and the third clock edge (3, T₀). The value T₀ associated with the first initiating event is not equal to T₀ not associated with the seventeenth pulse. The term “T₀” is used for convenience to refer to the offset value of the event assigned to cell 0. Similarly, the terms T₁-T_{f} are used to refer to the offset values of events assigned to cells 1-f, respectively, although the offset values may differ for each associated event.

The eighteenth event 44C involves a transition from low (logic 0) to high (logic 1), is recorded as a logic 1, is assigned arrival time (3, T₁), and is distributed to cell 1 in the first row. The nineteenth event 44D involves a transition from high (logic 1) to low (logic 0), is recorded as a logic 0, is assigned arrival time (3, T₂) and is distributed to cell 2 in the first row. The twentieth event 44E is a transition from low (logic 0) to high (logic 1), is recorded as a logic 1, is assigned arrival time (3, T₃) and is distributed to cell 3 in the first row. The twenty-first event 44F involves a transition from high (logic 1) to low (logic 0), is recorded as a logic 0, is assigned arrival time (3, T₄), and is distributed to cell 4 in the first row. The twenty-second event 44G involves a transition from low (logic 0) to high (logic 1), is assigned arrival time (3, T₅), is recorded as a logic 1, and is distributed to cell 5 in the first row. The twenty-third event 44H involves a transition from high (logic 1) to low (logic 0), is recorded as logic 0, is assigned arrival time (3, T₆), and is distributed to cell 6 in the first row. Finally, the twenty-fourth event 44I involves a transition from low (logic 0) to high (logic 1), is recorded as a logic 1, is assigned arrival time (3, T₇), and is distributed to cell 7 in the first row. Thus, the sequence of events during the third clock pulse is 101010101. The bit pattern associated with the sequence of events during the second clock pulse is 11101011010001.

Referring now to the deskewing operation on the first six events in row three, generally speaking “deskewing” involves accounting for path length differences in the time stamp 20 and distribution 18 circuitry. The length of the various processing paths in the distributor and time stamp circuitry may vary for each secondary event stream. Thus, the time for each secondary event stream to be routed to the computational matrix 22 may vary slightly. To maintain proper relative timing between events as received from the DUT 12, the deskewing operation accounts for these slight timing deficiencies. The deskew value will be zero for the longest path, and some value to account for shorter path lengths through the distributor.

In some instances, the deskewing operation may cause the adjusted (deskewed) arrival time value for an event to exceed the test system clock pulse the event was first associated with. FIG. 6D, similar to FIG. 6C, illustrates the actions that occur during the deskewing operation when a deskewed time value exceeds the originally assigned test system clock pulse value. Referring to row 2, in this example, the event in column 5 was originally assigned an arrival time (0, T₅). If the offset value T₅ (after deskew) exceeds the time of the first system clock pulse, then the event is associated with the following clock pulse. Thus, in this example, the event is changed from (logic 1, clock pulse=0, T₅) to (logic 1, clock pulse=1, T₅) and is moved back to cell 5 of row 1. Typically, deskew adjustment values will be small, but if the raw time value is near the end of a system clock period the time added for deskew may result in a calibrated time which is larger than a system clock period. In this case, the system clock period is subtracted from the deskewed number, and the time stamp is moved back one period.

The deskewing operation typically will not require the time stamp to move more than a single pipeline cycle (i.e., move back one cell in a column). If testing a multilane signal, deskew may require more than one full clock cycle adjustment, so enough pipeline stages should be provided to account for the multilane path skew: Multilane busses typically require signal distribution and a corresponding time stamp array for each signal in such a bus.

After calibration, the event time will have been transformed from the raw time stamp value to account for linearization and deskewing operations. As discussed in further detail below, this transformation may result in assigning the calibrated time stamp to either a later or an earlier clock cycle. Referring again to FIG. 4, either the raw or the calibrated time stamp values for each event may be recorded in a memory array 130 for later analysis. A counter 140 configured to count the test system clock may also be recorded in the memory array and associated with the raw and/or calibrated time stamps. In one example, the counter value together with the calibrated time stamp is represented in the form (n, f), where n is the count and f is the time stamp.

An event stream may be associated with a data stream or, if the data path of which the data stream is a part is one of several streams associated with a source clock, then the event stream may be representative of the source clock. If so, then the calibrated source clock time stamp will be a reference clock correctly associated with the test system clock. This corrected reference clock time stamp value may be made available to the time stamp circuits to establish the proper nominal time value for comparison purposes.

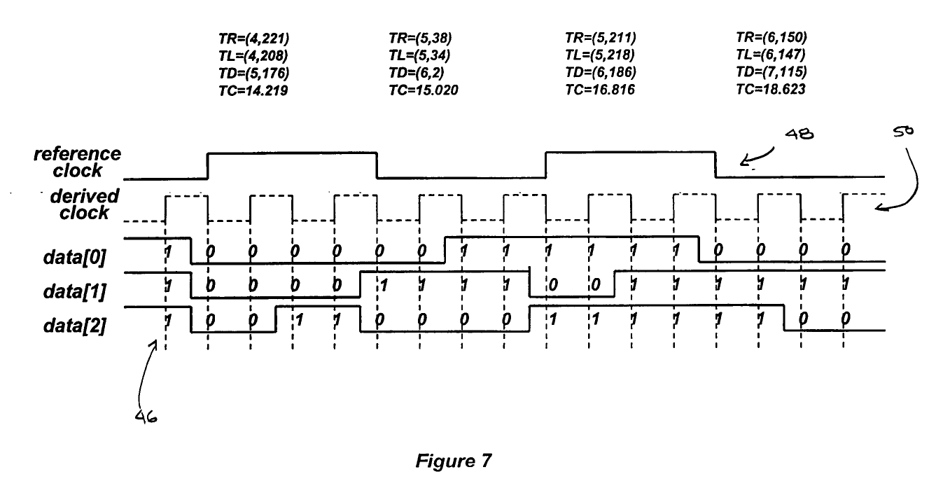

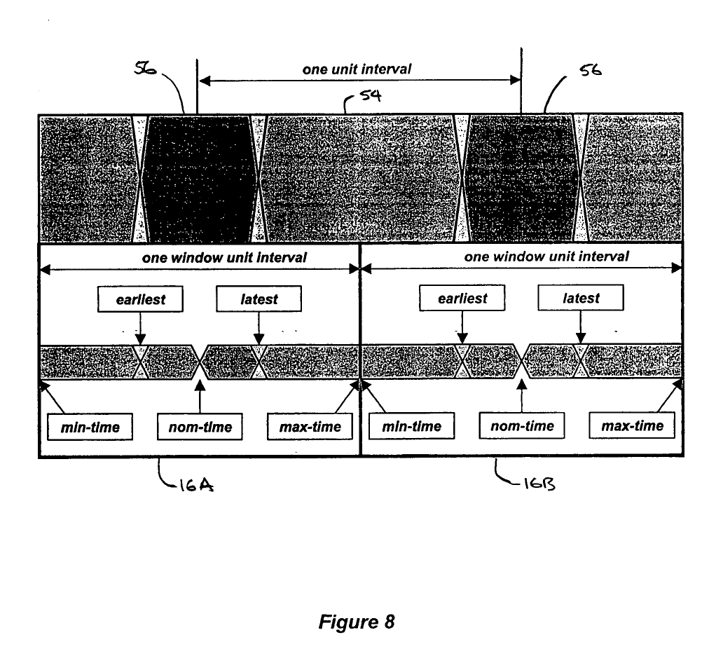

FIG. 7 is a waveform diagram illustrating three data event streams 46 (data[0]-data[2]), a DUT reference clock stream 48, and a derived clock stream 50. In this example, the reference clock is one-fourth the frequency of the (implicit) derived clock shown in dashed lines. A receiving device must be able to generate an internal clock four times the reference clock frequency, and align the incoming data streams to assure stable data at the time of each reference clock transition. In the present invention, event arrival time value generated as a function of the reference clock transitions are used to calculate transition window parameters for the reference clock. In this example, the reference clock is 500 MHz and therefore has one billion transitions per second. The derived clock is then 2.0 GHz, enabling a bit rate of 4.0 GBPS. At the top of FIG. 7 are sample reference clock time stamp values where “TR” indicates a raw time stamp, “TL” indicates a linearized time stamp, and “TD” indicates a calibrated time stamp (linearized and deskewed). TC is the calibrated reference clock time values calculated from the time stamps assuming 2.5 ns clock and 256 bit resolution. Since a 2.000 ns period cannot be generated exactly using integer multiples of 2.5/256 ns, there is a small round off error in the calibrated time values noted above.

Following calibration, the events are assigned to a transition window (operation 150, FIG. 4). Referring again to FIG. 3, a diagram of a digital data stream transition window 16, in accordance with one aspect of the present invention, is shown. A stream of digital data, which as indicated above may be data or clock values, is viewed as a sequence of data items or events. Each item in the sequence is represented by one of several characters, for example a digital 1 and 0. Embodiments of the present invention associate a stream of digital data from a DUT output with a contiguous sequence of transition windows, such as the transition window of FIG. 3. As mentioned above, each column (and associated cells) of the matrix of FIGS. 6A-6E, may be associated with a transition window. Moreover, each row may be characterized as a contiguous time-related sequence of transition windows. The sequence of transition windows covers the time duration of the event stream. The row of computational cells is wide enough to account for the possible number of events during a given clock pulse.

FIG. 8 illustrates a conventional unit interval 52 and associated eye diagram contrasted with two sequential transition windows (16A, 16B) of the present invention The eye diagram includes a central region 54 corresponding to the time when a logic state for an event is valid. Unlike a conventional unit interval that is defined based on when a data value is valid, e.g., when the pulse is either high or low and not in a state of transition, each transition window covers the boundary 56 between two bits of data in the data stream, and extends into a portion, for example half, of the time interval associated with each of the two bits. The expected time of any logic transition between bits in the digital data stream is therefore contained within one transition window of the sequence of windows. In a conventional unit interval 52, the expected time of a logic transition is in the area 56 where an event is considered invalid.

Referring again to FIG. 4, in operation 160, transition windows 16 are defined according to an event stream unit interval definition, in one embodiment. The event stream UI definition involves a nominal unit interval, the reference clock source (e.g., a source clock, an external reference clock or the embedded clock), maximum edge displacement (e.g., the maximum specified edge position deviation, which may be ±0.2UI, in one example), and accumulated drift correction. An example of an event stream UI definition is a 6.4 GBPS self-timed serial data stream, with embedded reference clock, 10% maximum edge displacement, and drift correction of 0. The event stream UI definition refers to the UI definition for an event stream. In one example, transition window parameters may be derived from the UI definition. Event stream UI definition can be updated as frequently as each test system clock cycle. In some implementations, the event stream UI definition is not updated at all or is updated only at the beginning of a test for a single stream of data of any length. If the event stream UI definition is not updated during the course of a test, then there will be no correction applied for accumulated drift of the actual edge transition times, as might occur if the device heats or the device power supply drifts.

Referring to FIGS. 3 and 8, as mentioned above, each transition window 16 has five associated time values, in one example, that are a function of the event stream unit interval definition or specification for a given DUT. There are many possible sets of specifications for a data stream, such as synchronous data streams, self-timed data streams, source-synchronous data streams, and reference clock synchronous data streams. First, each transition window has a minimum time value that is the earliest time a data stream transition can be assigned to the window. A transition occurring before the minimum time will be assigned to the previous window in the sequence of windows. Second, each transition window has a maximum time value that is the latest time a transition can be assigned to the window. A transition occurring after the maximum time will be assigned to the next window in the sequence of windows. As mentioned earlier, the WUI is the difference between the minimum and maximum time values. Third, each transition window has a nominal time value that is the time within a window at which a transition is expected to occur. Fourth, each transition window has an earliest time value, which is the earliest a transition is allowed to occur in a window according to the device performance specifications. Transitions too early (but within the window) are flagged as errors, in one embodiment. Finally, each transition window has a latest time value, which is the latest time a transition is allowed to occur in a window according to the device performance specifications. Transitions too late (but within the window) are also flagged as errors, in one embodiment.

The complete sequence of transition windows covers the entire test time. Therefore, every transition will be assigned to a window in the sequence. Not every window will contain a transition, however. Two successive identical data items (for example 00 or 11) can be separated by a window, with no actual logic transition taking place in the window. If there is no transition within a window, then the two items of data in the stream will be set to the same logic value.

Aspects of the present invention may be employed for testing synchronous data streams by computing the five time values for each transition window for each vector in the test program. Test vectors are typically defined for synchronous tests to be either input or output, and can change from one cycle to the next. For example, in conventional testing systems, a test vector may specify that the vector period is P, the data must be 0 at “time zero” (“TZ”) of the vector, and make a transition to 1 at “leading edge” (“LE”) time. The specification may also require that the transition from 0 to 1 must be within some error margin (M) of the LE transition time. If the test system clock is the same as the vector period, then the five time values of the transition window are defined as:
Minimum time value=0;
Maximum time value=P;
Nominal time value=LE;
Earliest time value=LE−M; and
Latest time value=LE+M.

In some ATEs, the test system clock frequency and test vector frequency are not the same, but translations create exact correlations between them. Such translations are described in commonly held U.S. Pat. No. 5,212,443, the Event Sequencer patent referenced earlier. In one implementation of the present invention, the time values assigned to a transition window 16 are forwarded as (test clock cycle, fraction of test clock cycle). For purposes of example, five transition windows are defined in Table 1 below for an ATE 10 with a test system clock period of 5 ns, a resolution of 256, for a test vector period of 1.25 ns, a leading edge time (LE) of 0.625 ns and a margin of error (M) of 0.1375 ns. In this example, the earliest time value is eight least significant bits earlier than the nominal time, and the latest time value is eight least significant bits later than the nominal time value.

TABLE 1
Sample Transition Windows

| | Minimum | Maximum | Nominal | Earliest | Latest |
|---|---|---|---|---|---|
| | Time Value | Time Value | Time Value | Time Value | Time Value |
| | (Cycle, | (Cycle, | (Cycle, | (Cycle, | (Cycle, |
| | Fraction) | Fraction) | Fraction) | Fraction) | Fraction) |
| Transition | (0, 0) | (0, 63) | (0, 32) | (0, 24) | (0, 40) |
| Window (0) | | | | | |
| Transition | (0, 64) | (0, 127) | (0, 96) | (0, 88) | (0, 104) |
| Window (1) | | | | | |
| Transition | (0, 128) | (0, 191) | (0, 160) | (0, 152) | (0, 168) |
| Window (2) | | | | | |
| Transition | (0, 192) | (0, 255) | (0, 224) | (0, 216) | (0, 232) |
| Window (3) | | | | | |
| Transition | (1, 0) | (1, 63) | (1, 32) | (1, 24) | (1, 40) |
| Window (4) | | | | | |

For reference, the first transition window (transition window (0)) shown in the above Table 1 is calculated as follows, where P is the Unit Interval period:

| | |
|---|---|
| Minimum Time Value: | (Cycle = 0, 0) |
| Maximum Time Value: | (Cycle = 0, P − 1 LSB = (1.25 ns/5 ns × |
| | 256) − 1 = 63) |
| Nominal Time Value: | (Cycle = 0, P/2 = 32) |
| Earliest Time Value: | (Cycle = 0, P/2 − P/8 = 24) |
| Latest Time Value: | (Cycle = 0, P/2 + P/8 = 40) |

The transition windows (1)-(4) and associated time values are defined similarly.

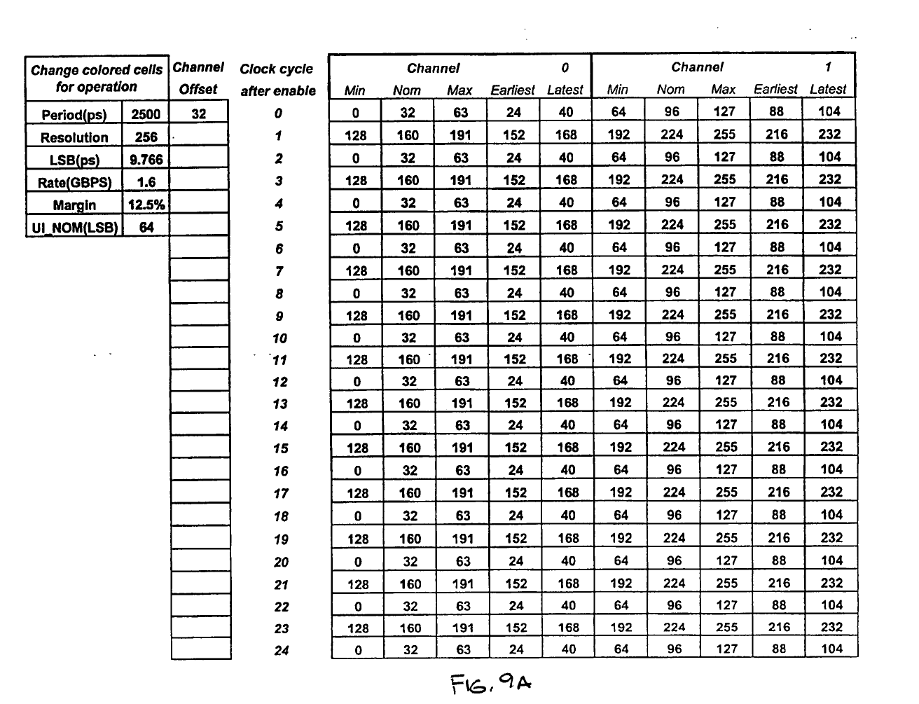

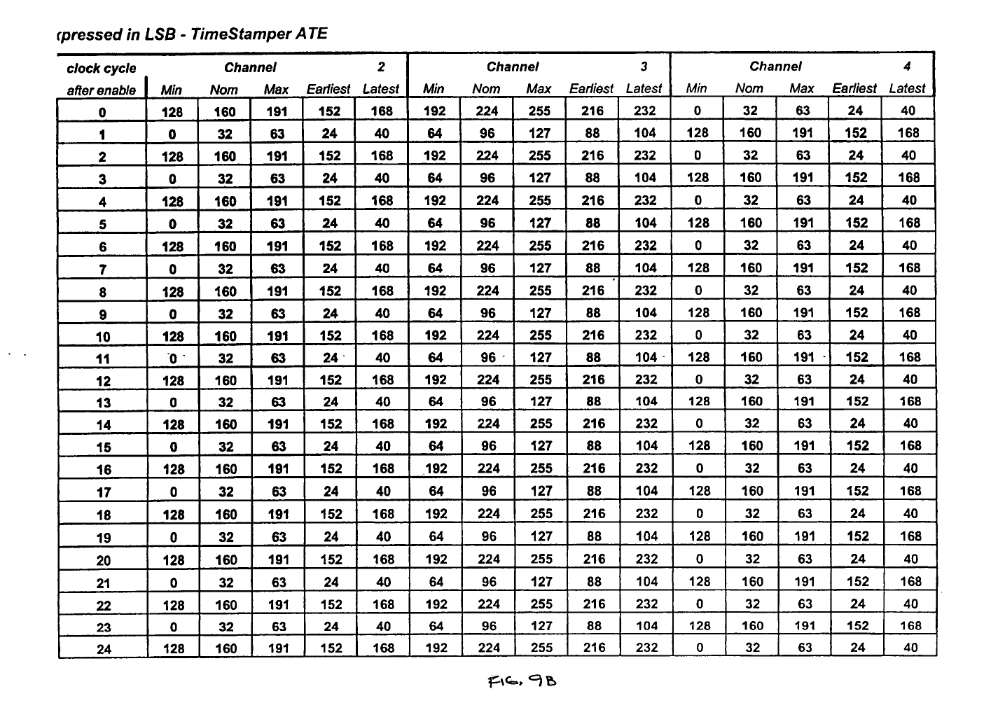

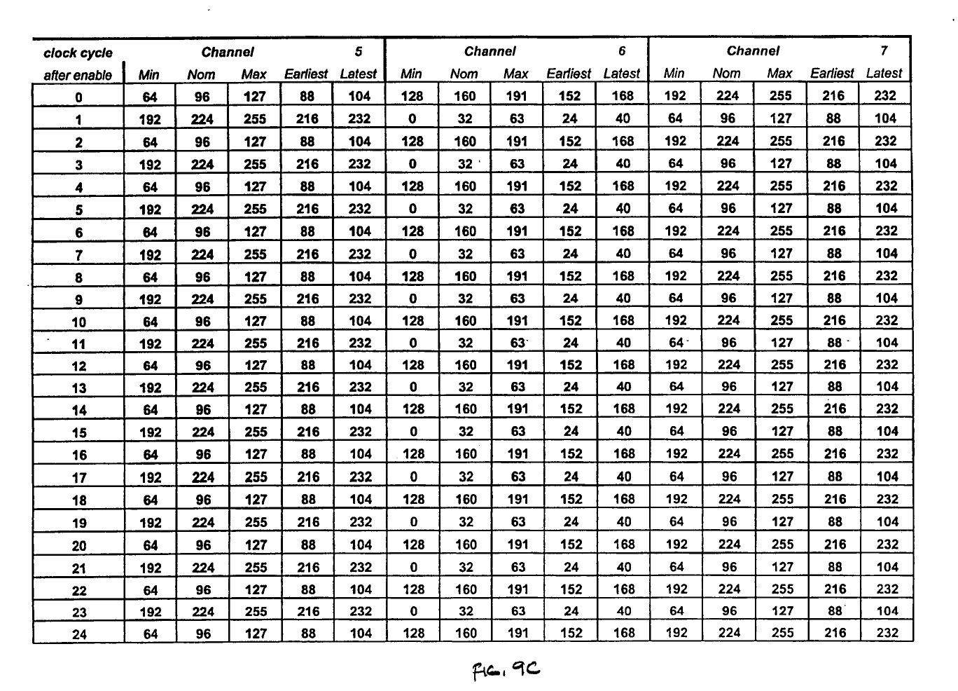

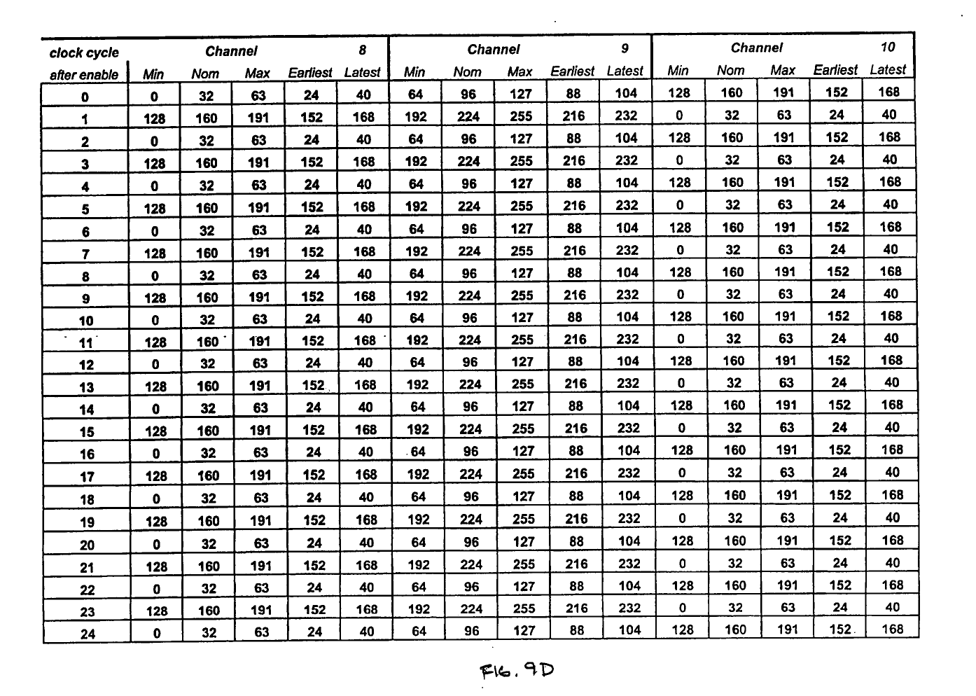

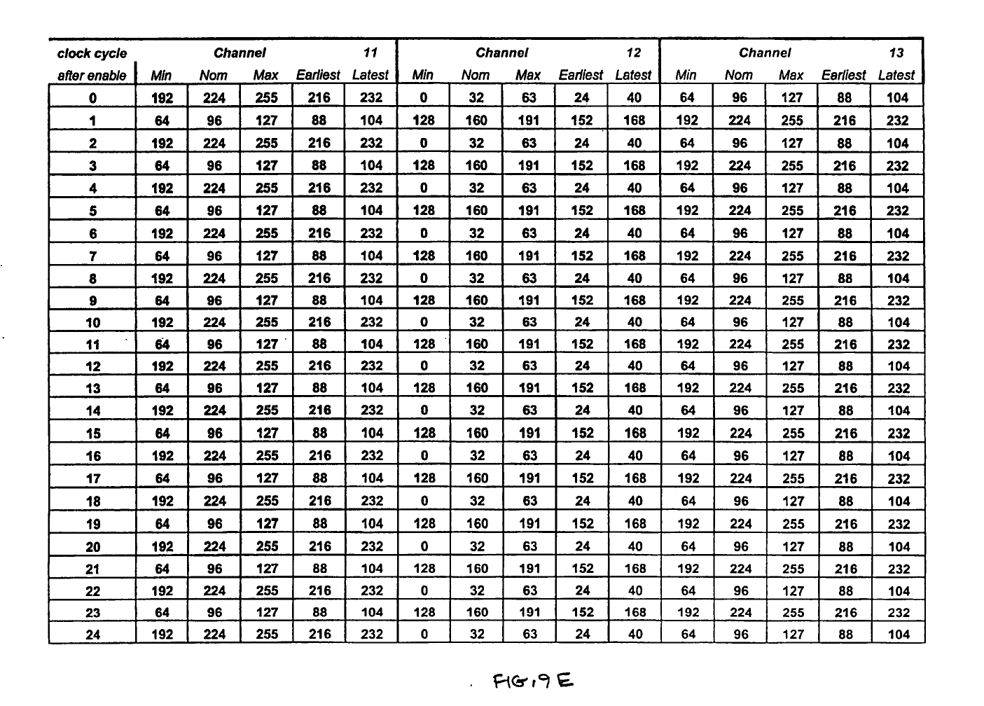

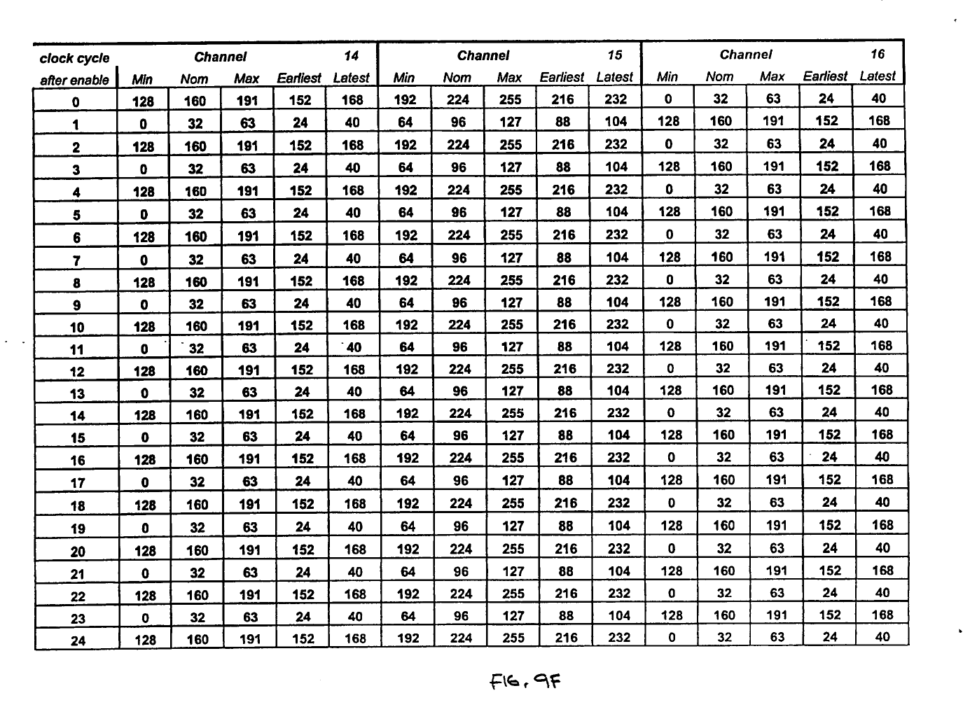

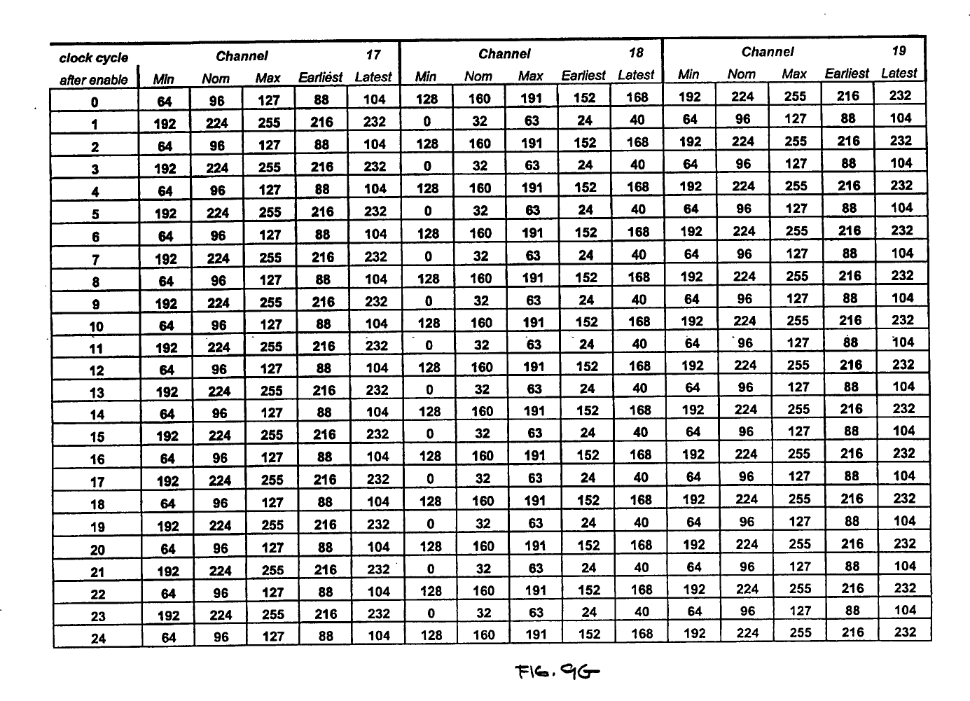

FIGS. 9A-9G, are tables illustrating transition window definitions for a 1.6 GBPS data stream, a test system clock with a 2500 picosecond period, a test system clock fractional resolution of 256 bits, a least significant bit (“LSB”) of 9.766 picoseconds, a transition window unit interval size of 64 bits (0-63), and a 12.5% margin, which is the allowed deviation of a transition edge from the nominal transition edge, expressed as a percentage of the transition window unit interval. The computational matrix associated with the transition window definitions of FIGS. 9A-9G would be 20 columns wide as up to 20 transitions might occur during a single test system clock pulse.

Referring to FIG. 4, in the transition window definition operation 150, a sequence of transition window definitions are calculated each clock cycle and transferred to each cell of row three of the processing matrix. In subsequent clock cycles, new transition window values are transferred into row three, and the values in row three are transferred down to the fourth row. In subsequent clock pulses, the transition window time values increment down one row within the column (i.e., move to subsequent pipeline stages). Thus, the transition windows, in one implementation, are initially fed into the computational cells of row 3 and then are propagated downward in each column each clock cycle. Depending on any particular implementation, the transition window definition may be routed to other rows as well, may be calculated explicitly at a later pipeline stage, may be calculated directly at the computational cell, may be routed to each row rather than along columns, or otherwise provided to the cells.

Self-timed data streams contain timing and logic information. Each transition indicates a logic state change and also the time of a clock edge. A self-timed data stream is defined by UI edge jitter and drift specifications. Aspects of the present invention may be employed for testing self-timed data streams by computing the five time values for each transition window. In one example, the five transition time value calculation for a self-timed data stream with the following specifications. N transition windows identified by I (0<=I<=N−1), a test system clock period of N*UI, a maximum jitter of 0.1*UI, and no drift, then if LSB is the test system timing least significant bit, a transition window (I) is defined as:
minimum time value (I)=I*UI;
maximum time value (I)=I*UI+UI−1 LSB;
nominal time value (I)=I*UI+0.5*UI;
earliest time value (I)=I*UI+0.4*UI; and
latest time value (I)=I*UI+0.6*UI.

In the following Table 2, sample transition windows for a self-timed data stream with a clock period of 2.5 ns, and a resolution of 1024. If the UI for the self-timed serial data stream is 250 ps (which is 102.4 LSB's), then the parameters will have to be rounded to the nearest integer value. This rounding does not create any ambiguity in window assignment.

TABLE 2
Sample Transition Windows for Self-timed Data Stream

| | Minimum | Maximum | Nominal | Earliest | Latest |
|---|---|---|---|---|---|
| | Time Value | Time Value | Time Value | Time Value | Time Value |
| | (Cycle, | (Cycle, | (Cycle, | (Cycle, | (Cycle, |
| | Fraction) | Fraction) | Fraction) | Fraction) | Fraction) |
| Transition | (0, 0) | (0, 102) | (0, 51) | (0, 41) | (0, 61) |
| Window (0) | | | | | |
| Transition | (0, 103) | (0, 204) | (0, 154) | (0, 144) | (0, 165) |
| Window (1) | | | | | |
| Transition | (0, 205) | (0, 306) | (0, 256) | (0, 246) | (0, 267) |
| Window (2) | | | | | |
| Transition | (0, 307) | (0, 409) | (0, 358) | (0, 348) | (0, 369) |
| Window (3) | | | | | |
| Transition | (0, 410) | (0, 511) | (0, 461) | (0, 451) | (0, 472) |
| Window (4) | | | | | |

In the event that drift and transition window time values are not an exact divisor of the test system clock period, then the five transition time values may require adjustment, perhaps as frequently as at each successive test system clock cycle. When the ATE first starts receiving a serial data stream there is an initial alignment task as a first transition in the serial data stream might appear at any time within a test system clock cycle. Referring to Table 3 below, the first transition is recognized by an embodiment of the invention as a Nominal Transition Time for the first window. It can then be used to calculate the other four window parameters from the predefined UI and maximum jitter. For example, suppose a UI of 500 ps, a test system clock period of 400 MHz, and a maximum jitter of 0.1 UI. Suppose the first transition occurs at (5,851). Then, the window parameters are calculated for the first five transition windows as follows:

TABLE 3
Sample Transition Windows Derived as a Function
of the Arrival Time of the First Transition

| | Minimum | Maximum | Nominal | Earliest | Latest |
|---|---|---|---|---|---|
| | Time Value | Time Value | Time Value | Time Value | Time Value |
| | (Cycle, | (Cycle, | (Cycle, | (Cycle, | (Cycle, |
| | Fraction) | Fraction) | Fraction) | Fraction) | Fraction) |
| Transition | (5, 800) | (5, 901) | (5, 851) | (5, 841) | (5, 862) |
| Window (0) | | | | | |
| Transition | (5, 902) | (5, 1004) | (5, 953) | (5, 943) | (5, 964) |
| Window (1) | | | | | |
| Transition | (5, 1005) | (6, 82) | (6, 32) | (6, 22) | (6, 43) |
| Window (2) | | | | | |
| Transition | (6, 83) | (6, 185) | (6, 134) | (6, 124) | (6, 145) |
| Window (3) | | | | | |
| Transition | (6, 186) | (6, 287) | (6, 237) | (6, 227) | (6, 248) |
| Window (4) | | | | | |

Referring again to FIG. 4, the first three operations (100, 110, 120) involve distributing an event stream from a DUT into one or more secondary event streams, assigning a time of arrival to each event in the secondary event streams, and calibrating the assigned time for each event. Next, events are assigned to a transition window (operation 150) based on the calibrated time value for the event. Generally, if the calibrated time exceeds the minimum time value or maximum time value, it is shifted into the proper transition window, i.e., where the event time is between the minimum time value and the maximum time value. When in the proper transition window, the edge displacement is calculated in operation 170. In one example, the calibrated time for the event is compared to the nominal time value, the earliest time value, and the latest time value associated with the transition window. The comparison automatically yields the passing margin. If the calibrated time for the event is less than the earliest time value or greater than the latest time value, then an error flag is set (operation 180).

As discussed above, each event has an associated calibrated time value corresponding to the time at which it was received from the DUT 12. Additionally, each column in the processing matrix is associated with a transition window 16 with a nominal time value, a minimum time value, a maximum time value, an earliest time value and a latest time value. As will be discussed in more detail below, the time values for a transition may be adjusted on the fly, if needed. Assignment of events to the proper transition window involves comparing the event time with the transition window time values for the column or computational cell that the event is presently assigned to. If the event time matches the transition window time values, then the event is assigned to the correct column/transition window. If the event time does not match the transition window, then the event is shifted until it matches a transition window. Through shifting all of the events are assigned to the proper transition window and a bit sequence associated with an event sequence may be properly composed.

FIG. 6E exhibits the flow of events yet to be captured (the events occurring during the fourth clock cycle 58 after enable); it also exhibits the pipelining of the data that was captured in the preceding three clock cycles (32, 34, 36). Further, in rows three to ten, arrows from cell to cell exhibit the flow of events as comparisons are made to the time values of each event and the time values of the transition windows associated with the respective cells. Particularly, the diagram illustrates the alignment of the first six events (40A-40F) captured during the first clock cycle 32 with the proper transition windows. In any particular instance, the flow of events will depend on various factors including the pattern and timing of bits and events in an event sequence.

With reference to the first three events (40A, 40B, 40C) captured in the pipelines 0-2, the calibrated event time for these events is compared to the maximum-time value of the associated transition windows of channels 0-2. In this example, the event times of the first three events match the transition windows of the first three columns, so no shifting is required. In one implementation of the present invention, the transition window time values of each computational cell are first established to account for the initial timing offset that occurs between the beginning of the first clock pulse and the first event. Alternatively, it is unnecessary to account for the time difference between first event and the first clock pulse. The data stream starts asynchronously to the ATE clock, so embodiments of the invention determine times between transitions and extract the data from them. Consistent measurement, however, is possible without a specific enabling event.

In another embodiment of the invention, the data transfer prior to any input signal is a continuous stream of either zeroes or ones depending on the quiescent output state of the DUT signal pin or pin pair being tested. Whenever data arrives, the transition window calculations are updated to correspond to the transition time just received. For example, suppose that at the start of a testing process a serial data input is quiescent, but the ATE 10 has been programmed to expect a serial stream with a UI of 500 ps (i.e. 2 GBPS data stream). Suppose also that the serial line is inactive at logic zero until a transmission request is sent from the ATE to the DUT (the character of the transmission request does not matter). Before the transmission request is sent, the time stamping circuit 20 of the ATE 10 will generate successive words containing all logic zeroes with a UI of 500 ps. However, as the test program has not sent the transmission request, it is preprogrammed to ignore the transmitted words. When the transmission request is received by the DUT 12, transmission will be initiated. The first transition will be to logic one at an unpredictable time after the transmission request is issued from the ATE 10. Subsequent transitions are expected at the times established by the specified UI (500 ps). Therefore, the measured time of the first arriving transition can be used unambiguously to define all window parameters for successive transitions, subject to the updating procedures established by the test program.

Referring again to FIG. 6E, the transition window of channel 0 is initially defined as a function of the first transition (i.e., event 40A) received after the ATE 10 is enabled. As discussed above, the first calibrated transition is defined as nominal for the transition window of the first channel (channel 0), and subsequent channels are defined as a function of the first channel window definition Prior to enabling the ATE or while the ATE is operating, all of the transition windows are defined with the assumption that the first transition will occur in channel 0 in the nominal time. Referring to the fourth event 40D, which is first sent to pipe 3, it can be seen that this event is shifted two cells to the right between rows 3 and 5. The event time for the fourth event is greater than the maximum time value for the transition window of pipe 3 so the event is shifted one cell to the right in the next clock cycle (i.e., fourth clock cycle 58). All calibrated or corrected events to the right (events 40E and 40F in pipes 4 and 5 of row 3) are also shifted (to pipes 5 and 6 of row 4), as they are also compared to the maximum-time values and consequently shifted as their values exceed the maximum-time values of the associated transition windows. In the third comparison of row 5, after two shifts, the event times (40D, 40E, 40F) are aligned with the proper transition windows (cells 5, 6, 7, row 5) and no further shifting is required. Thus, in row 5, all the event times are less than the associated maximum-time value for the associated transition windows.

The event stream (40A-40F) occurring during the first clock cycle is 010101, and the associated bit pattern is 0100010. The event transition values (1 or 0) are initially transferred in the computational cell with the associated time stamp (e.g., cell 0 initially received the first event with data value 0, the first clock cycle 0, and clock edge offset T₀ (0, 0, T₀). The event values then follow or are shifted along with each event as it makes it way through the matrix. As such, event values are transferred both vertically and horizontally as the case may required. Referring to row 5, logic values are assigned to the computational cells as (0, column 0; 1, column 1; 0, column 2; null value, column 3; null value, column 4; 1, column 5; 0, column 5; and 1, column 6). There is a null value in columns 3 and 4, as the event values initially assigned to those columns have been shifted after comparison with the transition window time values.

To reconstitute the received bit pattern from the event values, the first event value in the cell immediately to the left or preceding a null value or sequence of null values is assigned to each computational cell with a null value. As such, because there is a logic 0 in cell 2 of row 5, a logic 0 is assigned to computational cells 3 and 4 in the fifth row. Thus, in row 5, columns 0-7 have the following bit pattern, 0100010, which is the bit pattern of the event sequence received during the first clock cycle. In operation 180, the inferred bits (i.e., data word) are entered into a data word. The data word is then transferred (operation 200) to a data memory. The events transferred into the processing matrix in clock cycles subsequent to the first clock cycle are processed in the same manner to reconstitute the entire received bit pattern.

Referring again to operation 170 of FIG. 4, the ATE calculates edge displacement for each event. When alignment of an event with a transition window is achieved, the computational cell in which alignment is achieved calculates the difference between the nominal edge time value for the transition window and the calibrated event time. The edge displacement calculation may also be performed in other cells later in the processing matrix. If the difference exceeds a specified margin, then, in operation 180, an error flag is set for that specific event.

In one particular example, the margin is defined by the earliest and latest time value for the window. Thus, if the event time lies between the minimum time value and the earliest time value for the window or lies between the latest time value and the maximum time value for the window, an error flag is set. Also, the passing margin is calculated, without searching, by determining the difference between the minimum time and the calibrated event time or between the latest time value and the calibrated event time. Recall, if the value exceeds the maximum time value, the event is shifted until it is in the appropriate computational cell. Additionally, the cell establishes the value of the data term identified by the transition, and enables that data value to be propagated to the next diagonally adjacent cell if necessary.

In some instances, the time values associated with each transition window may change from one test system clock cycle to the next. In instances where the device is synchronized to ATE timing, the transition window time values may be determined in advance of the test. In other instances, where a DUT might not be controlled well enough for synchronization to the ATE, such as when the I/O rate is too fast, then the time values for the transition windows may require recalculation during the course of the test. Generally speaking, for source synchronous devices, window time value recalculation or updating is a function of the event times for the source synchronous clock. For self-timed devices, window time value recalculation or updating is a function of the transition time of the events and the expected transition time of the events.

When the tester detects a need for a drift correction, it accounts for drift in all five transition window time values in each channel Drift may be positive or negative. In one implementation, it is assumed that drift will be cumulative over many events (many tester clock cycles, even) so detection and correction can happen slowly over long but acceptable periods of time.

For synchronous tests, all window parameters can be precomputed unambiguously and corrections based on DUT output response times are unnecessary. The histograms (discussed below) report the deviations from expected transition times. For self-timed circuits, i.e. those with embedded clocks, the transitions are used to derive the clocks. Transitions should be close to the expected unit interval.

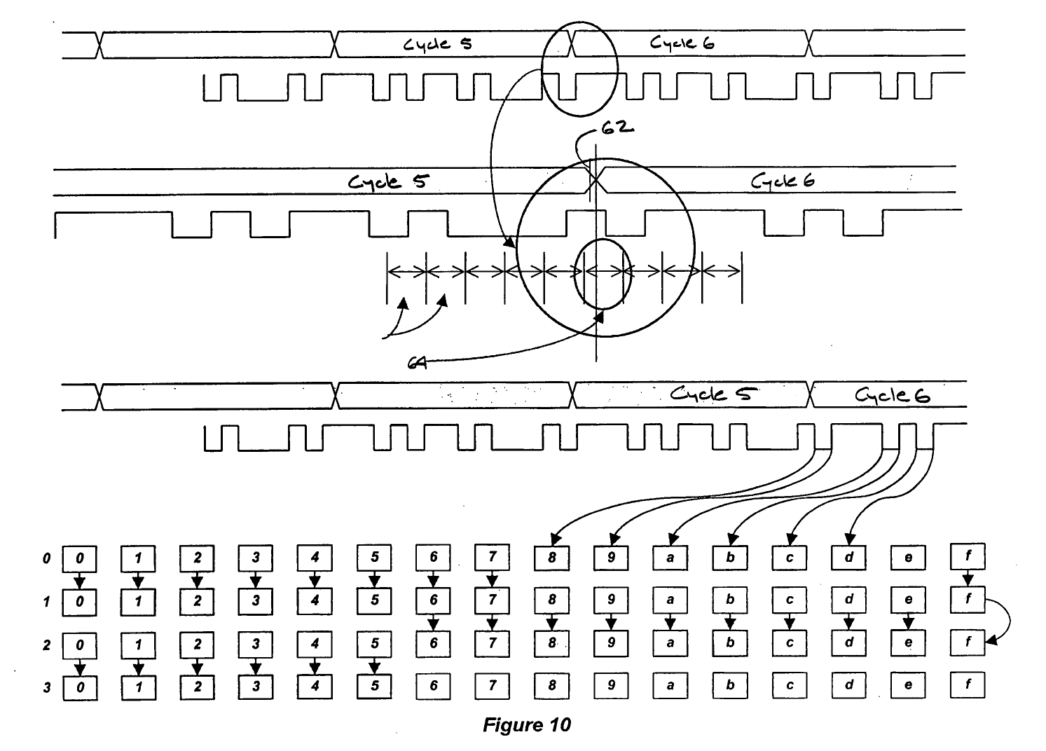

It is possible, and in most cases likely, that some of the transition windows will bridge a clock cycle boundary. The phrase “split window” refers to a transition window that bridges a clock cycle edge boundary. Referring again to Table 3, in this example, transition window 2 is split between tester clock cycles 5 and 6 (the minimum time value is 5,1005 while the other time values are 6, X). FIG. 10 provides an illustration of a split transition window, an event occurring in the split transition window, and illustration of moving the event to the previous clock cycle to properly align the event with the appropriate clock cycle. An edge 62 appearing at (5,1020), for example, will be assigned to split transition window 64, but will appear very nearly the end of tester clock cycle 5. To properly account for the event, the window parameters for this portion of the split window are expanded (a “window extension” by adding the value of a tester clock cycle in LSB's, in this example 1024 to the lower clock cycle value. Thus, with respect to the sample transition window (2) of Table 3:
(5, 1005) remains (5,1005)
(6,82) becomes (5,1106)((1024−1005)+82)+1005)=1106
(6,32) becomes (5,1056)((1024−1005)+32)+1005)=1056
(6,22) becomes (5,1046)((1024−1005)+22)+1005)=1046
(6,43) becomes (5,1067).((1024−1005)+43)+1005)=1067
   So the transition is recognized to have occurred 1056−1020=36 LSB earlier than the nominal time, and is also recognized to have occurred 1046−1020=26 LSB earlier than the minimum time permissible based on the jitter specification.

Generally speaking, there are at least three different scenarios that implementation of the present invention manage, including: no split windows, a transition in the first portion of a split window, and a transition in the last portion of the split window. When a window is split, a transition within the window could appear in either of two successive test system clock cycles (such as in cycle 5 or 6 with regard to the example above regarding an event occurring at (5,1005) associated with transition window 2 definition of Table 3). The first portion of the split window is the portion that would have registered a transition in cycle 5. The last portion is the portion that would have registered a transition in cycle 6.

Referring to FIG. 10, the event occurring in the split transition window occurs in the transition between two clock cycles, i.e., in a clock cycle boundary. To account for either no split window or a transition occurring in the first portion of the transition window, the split window is expanded numerically over the full transition range, as discussed above with regard to the extension of the transition window 2. To account for a clock cycle boundary in the last portion of the transition window, one tester clock period is added to the event time stamp and the event is moved to the previous transition window for comparison In this scenario, the event time assigned to a channel is less than the minimum time value for the channel. As such, the event actually “belongs” in the previous channel. But the event could not have been captured there, because the tester system clock logged time stamps before the event arrived. Numerically, as discussed above, the LSB value is added to the event time and the event is moved to the previous transition window for comparison as shown in the FIG. 10 where the event in channel f row 2, is assigned to channel f of row 3 (row 3 representing the clock cycle preceding the clock cycle associated with row 2).

In one example, the minimum time value number for a transition window is not corrected and one or more of the other four time value numbers may require extension. The extension, stated in another way, is: if an event time value number is less than the minimum-time value for the assigned transition window, add one tester period in system LSBs. For example, with reference again to transition window 2 of Table 3, the five window time values, before extension, are (5,1005), (6,82), (6,32), (6,22), (6,43). Window extension transforms these time values into (5,1005), (5,1106), (5,1056), (5,1046), (5,1067)—one tester period in system LSBs being 1024. The reader will note that the clock cycle integer (5 and 6 in this example) is reduced to account for the additional 1024 in the fraction window. This is physically accomplished by holding the window time values back one pipeline stage as described above.

Referring again to FIG. 4, in operation 220, after the events are assigned to the proper transition window and edge displacement is calculated (operation 170), a histogram is updated. In one example, the calibrated time stamp is subtracted from the nominal transition window value and the result is assigned to a histogram bin. If an error flag is set, then the time stamp is logged, if desired. Histograms may be used for at least two purposes. First, histograms illustrate noise, or jitter, in the data stream. Second, histograms provide the data input required to calculate drift, in one implementation. Table 4 below illustrates a sample histogram time bin definition For example, if the UI is 125 ps, a jitter distribution of +/−15 ps might be tolerable, a histogram using a bin width of 3 ps has twelve bins, defined in the table below shown as an example.

TABLE 4
Sample Histogram Time Bin Definitions

| | | No. of |
|---|---|---|
| Bin | Time Range Per Bin | Occurrences |
| Bin 1 | much too early (collects all errors < −15 ps) | 0 |
| Bin 2 | −15 to −12 ps | 3 |
| Bin 3 | −12 to −9 ps | 11 |
| Bin 4 | −9 to −6 ps | 20 |
| Bin 5 | −6 to −3 ps | 41 |
| Bin 6 | −3 to 0 ps | 67 |
| Bin 7 | 0 to +3 ps | 65 |
| Bin 8 | +3 to +6 ps | 38 |
| Bin 9 | +6 to +9 ps | 17 |
| Bin 10 | +9 to +12 ps | 8 |
| Bin 11 | +12 to +15 ps | 2 |
| Bin 12 | much too late (collects all errors > +15 ps) | 0 |

The raw data for the histograms are the differences between the calibrated event time stamp sorted into an appropriate transition window and the nominal time value for the window. Drift is extracted from a histogram as a continually increasing sum of errors between the nominal time and the actual time. As errors are binned their values are accumulated, and if the ATE has enabled drift tracking a correction is applied to the transition window time parameter to update consistently with the amount of drift detected. For example, suppose in 20 tester clock cycles, there are summed errors of 40 LSBs. Also, suppose the UI is 250 ps (4 GBPS). In this test, there is a drift of about 2 LSBs per clock cycle (40 LSBs drift/20 clock cycles). As such, a correction of 2 LSBs per transition window may be applied. If, however, the device changes and begins to drift in the other direction (or more in the same direction), the size of the correction is adjusted appropriately. The following table shows the first five transition windows in the above data stream before the drift correction is applied.

TABLE 5
Sample Transition Window Definitions Before Drift Correction

| | Minimum | Maximum | Nominal | Earliest | Latest |
|---|---|---|---|---|---|
| | Time Value | Time Value | Time Value | Time Value | Time Value |
| | (Cycle, | (Cycle, | (Cycle, | (Cycle, | (Cycle, |
| | Fraction) | Fraction) | Fraction) | Fraction) | Fraction) |
| Transition | (0, 0) | (0, 102) | (0, 51) | (0, 41) | (0, 61) |
| Window (0) | | | | | |
| Transition | (0, 103) | (0, 204) | (0, 154) | (0, 144) | (0, 165) |
| Window (1) | | | | | |
| Transition | (0, 205) | (0, 306) | (0, 256) | (0, 246) | (0, 267) |
| Window (2) | | | | | |
| Transition | (0, 307) | (0, 409) | (0, 358) | (0, 348) | (0, 369) |
| Window (3) | | | | | |
| Transition | (0, 410) | (0, 511) | (0, 461) | (0, 451) | (0, 472) |
| Window (4) | | | | | |

Applying the drift correction, we adjust the table to the following values:

TABLE 6
Sample Transition Window Definitions After Drift Correction

| | Minimum | Maximum | Nominal | Earliest | Latest |
|---|---|---|---|---|---|
| | Time Value | Time Value | Time Value | Time Value | Time Value |
| | (Cycle, | (Cycle, | (Cycle, | (Cycle, | (Cycle, |
| | Fraction) | Fraction) | Fraction) | Fraction) | Fraction) |
| Transition | (0, 2) | (0, 104) | (0, 53) | (0, 43) | (0, 63) |
| Window (0) | | | | | |
| Transition | (0, 105) | (0, 206) | (0, 156) | (0, 146) | (0, 167) |
| Window (1) | | | | | |
| Transition | (0, 207) | (0, 308) | (0, 258) | (0, 248) | (0, 269) |
| Window (2) | | | | | |
| Transition | (0, 309) | (0, 411) | (0, 360) | (0, 350) | (0, 371) |
| Window (3) | | | | | |
| Transition | (0, 412) | (0, 513) | (0, 463) | (0, 453) | (0, 474) |
| Window (4) | | | | | |

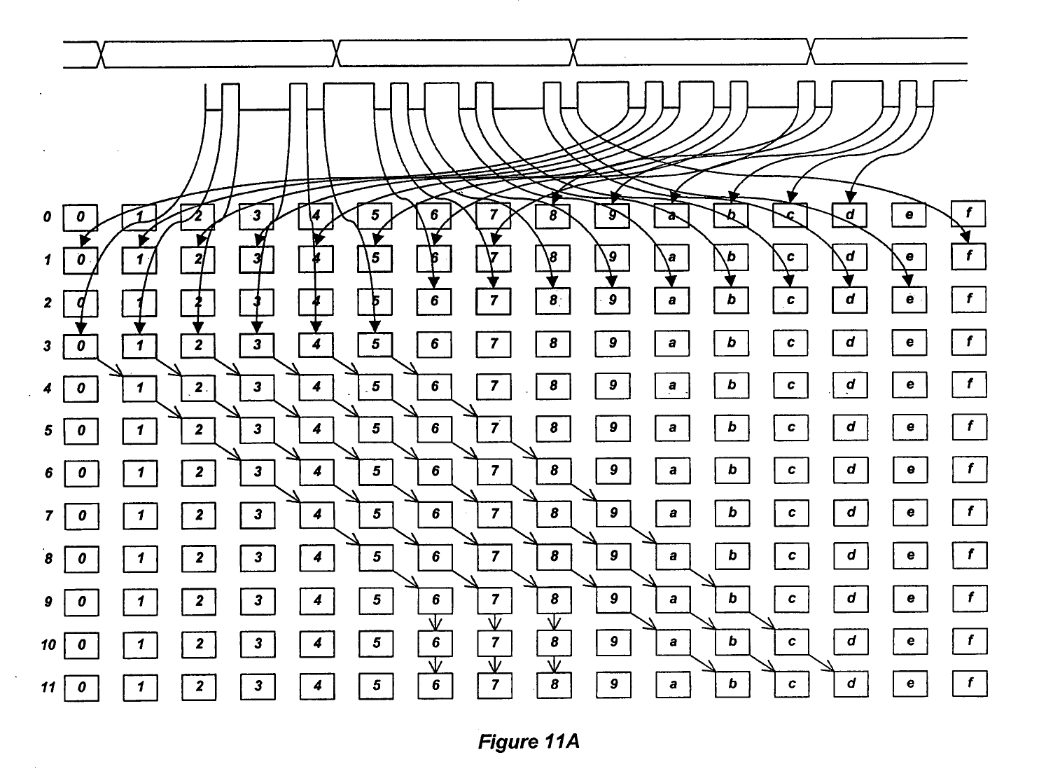

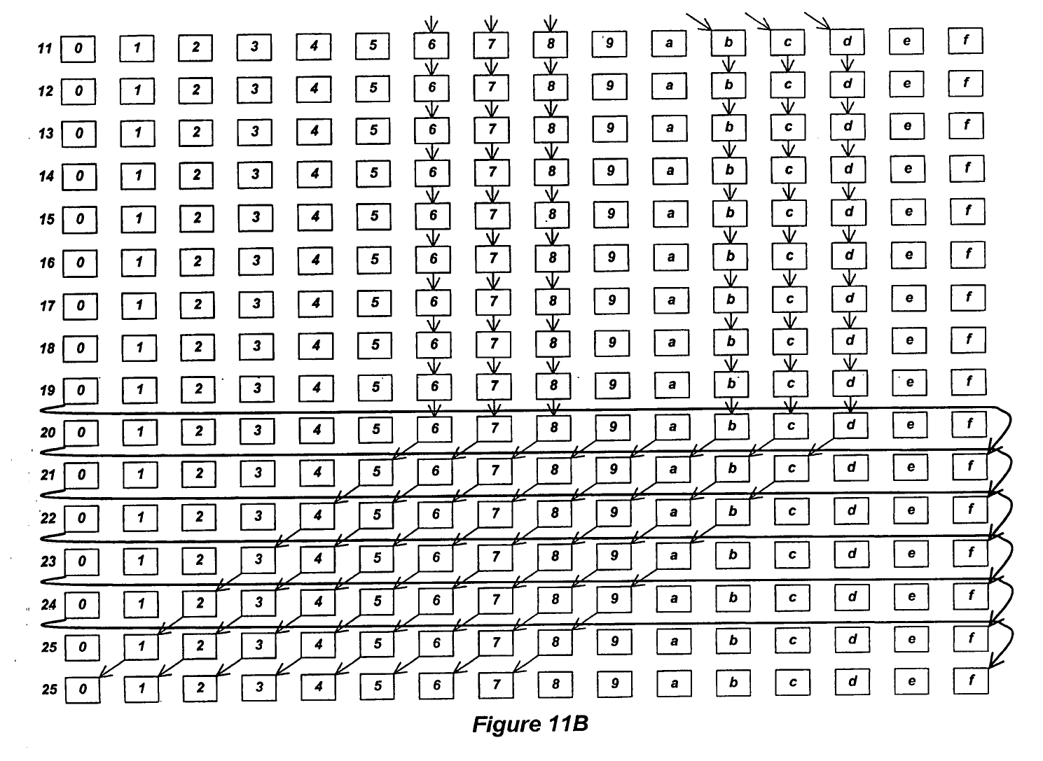

FIGS. 11 and 12 illustrate the flow of events through the processing matrix, in an alternative implementation of the present invention. The processing in the first three clock cycles is the same as described above with regard to FIGS. 6A-6C. However, in this example, the transition windows do not account for the difference in time between the first event and the transition of the full clock pulse. Thus, the first six events are shifted six columns in six clock cycles.

Thus, in row 9, the first six events have been shifted to account for the offset from the tester clock transition. In row 9 there is a null value in columns 0-5, and the event pattern 010101 in columns 6 through b. From rows 10-12, the events in the data pattern are shifted into the proper transition windows, resulting in the pattern of bits 01000101 in columns 6-e in row 12. The data value 0 is propagated to cells 9-“b”, where shifts in a previous cycle left a null value.

As shown in rows 20-25, to recreate the data word 01000101 and transfer it to a data memory, six left shifts are required to realign the start of the data word into the first column.

FIG. 12 exhibits the final alignment process. The first time stamp after data capture was enabled required six shifts to reach alignment with the transition window timing values. This then requires six shifts to the left to achieve the final word alignment required. The figure does not exhibit an additional nine rows that would be needed in order to allow for up to fifteen shifts if the first event after data capture enable were to have aligned with the last of the sixteen windows in the array. Note that these last sixteen rows require no computation, as the required shift was determined at the shift in row 9 in FIG. 11, where the alignment was achieved.

It is to be appreciated that the present invention has been described in detail with respect to certain embodiments and examples. The operations shown in the flowchart and various figures are illustrated in a particular example order, but modifications to the order are within the scope of the invention. Variations and modifications may exist which are within the scope of the present invention as set forth by the claims, the specification and/or the drawing figures.

1. A method for determining a pattern of output bits from an integrated circuit comprising:
obtaining a sequence of logic transitions that are a function of one or more bits from the integrated circuit;
determining a transition time of each logic transition in the sequence of logic transitions; and
deriving the pattern of output bits from the integrated circuit as a function of the transition time of each logic transition in the sequence of logic transitions.

2. The method of claim 1 further comprising the operation of:
comparing the pattern of output bits from the integrated circuit with an expected pattern of output bits.

3. The method of claim 1 wherein the operation of determining a transition time of each logic transition further comprises:
generating a plurality of transition time windows, each transition time window comprising a range of time when a logic transition of a bit of the pattern of output bits is expected; and
assigning each logic transition of the sequence of logic transitions to one of the plurality of transition time windows.

4. The method of claim 3 wherein the range of time for each transition window comprises:
a minimum time when the logic transition of a bit may be assigned to the transition window;
a maximum time when the logic transition of a bit may be assigned to the transition window;
an earliest time when the logic transition of a bit is expected to occur;
a latest time when the logic transition of a bit is expected to occur; and
a nominal time when a logic transition of a bit is expected to occur.

5. The method of claim 4 wherein the operation of assigning each logic transition of the sequence of logic transitions to one of the plurality of transition time windows comprises:
assigning a first logic transition in the sequence of logic transitions to a first transition time window if the logic transition time falls between a first minimum time that a logic transition may be assigned to the first transition time window and a first maximum time that a logic transition may be assigned to the first transition time window.

6. The method of claim 5 wherein the plurality of transition time windows comprise a sequence of time windows arranged such the first transition time window with the first maximum time value is followed be a second transition time window with a minimum time value following the maximum time value of the first transition time window.

7. The method of claim 6 wherein the operation of assigning a first logic transition in the sequence of logic transitions to a first transition time window further comprises shifting the first logic transition to the second transition window if the logic transition time for the first logic transition exceeds the maximum time value for the first transition window.

8. The method of claim 7 wherein the operation of deriving the pattern of output bits from the integrated circuit as a function of the transition time of each logic transition in the sequence of logic transitions comprises generating a bit pattern that is a function of the shift of the first logic transition to the second transition window.

9. A method for testing a stream of digital information, comprising:
recording an arrival time of each logic transition in the stream; and
comparing the arrival time to an expected arrival time for each logic transition in the stream.

10. The method of claim 9 wherein one or more data unit intervals may occur between each logic transition in the stream, further comprising:
determining a logic value of the one or more data unit intervals occurring between each logic transition.

11. The method of claim 10 further comprising:
comparing the logic values of the all data unit intervals with expected logic values.

12. The method of claim 9 further comprising
determining a difference between the recorded arrival time of each logic transition with an expected arrival time of each logic transition.

13. The method of claim 12 further comprising:
comparing the difference between the recorded arrival time and the expected arrival time with limits.

14. The method of claim 12, further comprising:
distributing the differences between the recorded arrival times and the expected arrival times into histograms.

15. A method for receiving a logic data stream, comprising:
receiving a logic data stream comprising at least a first logic transition and a second logic transition;
recording a first time of the first logic transition;
recording a second time of the second logic transition;
generating a sequence of time intervals as a function of the specification of the logic data stream;
determining a time between the first time and the second time;
comparing the time between the first time and the second time with the sequence of time intervals; and
determining a bit pattern associated with the logic data stream as a function of the operation of comparing.

16. The method of claim 15, wherein the operation of generating a sequence of time intervals further comprises the operation of multiplying a unit interval time specified for the logic data stream by a sequence of integers.

17. The method of claim 15, wherein the operation of generating a sequence of time intervals further comprises recording times of a sequence of logic transitions in a second logic data stream.

18. The method of claim 17, wherein said second logic data stream is contemporaneous with the logic data stream.

19. The method of claim 15, wherein the operation of generating a sequence of time intervals is performed prior to the operation of receiving a logic data stream comprising at least a first logic transition and a second logic transition.

20. The method of claim 19, wherein the operation of generating a sequence of time intervals further comprises performing a logic simulation of an apparatus that generates said logic data stream.

21. The method of claim 20 wherein the apparatus comprises a device under test.

22. The method of claim 15 wherein the sequence of time intervals comprises a contiguous sequence of transition windows, each transition window comprising:
a minimum time value when a logic transition may be assigned to the transition window;
a maximum time value when the logic transition may be assigned to the transition window;
a nominal time value when the logic transition may be assigned to the transition window;
an earliest time value when the logic transition may be assigned to the transition window; and
a latest time value when the logic transition may be assigned to the transition window.

23. A method for testing a logic data stream, comprising:
recording a time of a first logic transition in the data stream;
recording a second time of a second logic transition in the data stream;
comparing a time interval between the time of the first logic transition and the time of second logic transition to a known sequence of possible interval times;
setting a data value determined by said first logic transition time corresponding to the specific interval time in said known sequence of possible interval times; and
comparing the data value to a predetermined expected data value.
